(19) United States
(12) Patent Application Publication
(10) Pub. No.: US 2025/0321310 A1
(43) Pub. Date: Oct. 16, 2025

(54) System, Apparatus and Methods for Localization of Actual Dipole Field Positions

(71) Applicant: Merlin Technology, Inc., Kent, WA (US)

(72) Inventors: Timothy Shaw, Seattle, WA (US); Christopher Cavage, Bellevue, WA (US); John E. Mercer, Gig Harbor, WA (US); Peter Beery, Seattle, WA (US); Sigurdur Finnsson, Kent, WA (US); Thomas J. Hall, Newcastle, CO (US)

(21) Appl. No.: 18/633,048

(22) Filed: Apr. 11, 2024

(51) Int. Cl. G01S 1/04; E21B 47/13; G01S 1/02; H01Q 9/44

(52) U.S. Cl. CPC G01S 1/0428; G01S 1/024; G01S 1/045; G01S 1/047; H01Q 9/44; E21B 47/13

(57) ABSTRACT

A locator includes a yaw sensor for measuring a yaw orientation of the locator and a triaxial antenna for receiving a dipole electromagnetic signal to generate flux components. A processor generates a relative yaw orientation characterizing a difference between the yaw orientation of the walkover locator and a reference yaw orientation of the transmitter and determines an actual position of at least one of the locate points relative to the walkover locator based on at least one measured set of the flux components, the relative yaw orientation and the measured pitch orientation of the transmitter. The locator can measure GPS positions of locate points at least for use in identifying an overhead position. Selected combinations of various positions and features relative to the transmitter and locator can be shown in isometric views. The locator can be configured for automatic switching between locating modes based on proximity to a plane of symmetry.

The present invention is generally directed to the field of tracking an inground tool having a transmitter which transmits a dipole locating signal and, more particularly, to a system, apparatus and methods for localization of actual dipole field positions.

One example of a class of prior art, for finding an inground tool having a transmitter that transmits a dipole locating signal, favors the use of locate points. By way of background, a locate point is a field defined point in an electromagnetic dipole locating field at the surface of the ground at which the flux lines are vertical. There are two locate points. A front locate point (FLP) is found at the surface of the ground ahead of the transmitter and a rear locate point (RLP) is oppositely found behind the inground tool. One approach for finding the locate points is described by U.S. Pat. No. 6,496,008 (hereinafter, the '008 patent) which is incorporated herein by reference. While the technique for utilizing the locate points described in the '008 patent is effective for purposes of ultimately finding a location directly above the transmitter, this technique involves a relatively complex multi-step process. First, the crew must use the locator to find the FLP and RLP. The crew can then mark the location of both locate points on the ground and use a string or other means to draw a line between the two points. Then, using the locator, the crew walks along that line until a locate line is displayed, which intersects the string at a point directly above the transmitter. Unfortunately, this point of intersection is shifted away from the point that is actually directly above the transmitter when the transmitter is pitched. In addition to the need for a multi-step process, it can sometimes be impractical or impossible to use both locate points due to terrain or other limitations. For example, one locate point can be inaccessible under a body of water, beneath a building or in an active roadway. Applicant recognizes that finding this overhead position based solely on measurements of the dipole field can be subject to some inaccuracy based, for example, on interference as well as a generally low gradient of signal strength of the dipole field near the overhead point.

As a time saving expedient, some drillers do not use both locate points, instead preferring to use only the FLP to serve as essentially a prediction of where a boring tool (supporting the transmitter) is heading. However, with this approach the actual position of the transmitter underground is not determined.

Applicant also recognizes that even the process for finding the actual location of the locate points in the '008 patent involves a methodical procedure. This procedure utilizes the mathematical construct of horizontal flux lines. While a horizontal flux line can be followed to a locate point with remarkable accuracy, it is important to understand that the horizontal flux lines are curved and do not represent a straight path to the locate point. The position of the locate point that is shown to the operator at a distance from the locate point is predicted and is not the actual position of the locate point. This is because the indication is based on a tangent to the local curvature of the horizontal flux line at a current location of the locator. The further the separation between the locate point and the locator, the greater the distance between the predicted location of the locate point and the actual locate point. Thus, the '008 patent is unable to display the actual position of a locate point without being subject to a lateral offset therefrom. The operator must take the time to use indications on the locator to follow the horizontal flux line to the position at which the locator indicates that it has arrived at the locate point such that the predicted location finally converges on the actual location. Applicant recognizes that it would be an advancement to display the actual location of a locate point when the locator is at a distance from the locate point without following a horizontal flux line.

Still another concern with respect to the prior art, which is shared by the '008 patent, resides in the way that points of interest are displayed. For example, when finding a locate point, the only point that is displayed to the operator is a predicted position of the locate point relative to the locator. Similarly, when finding the locate line, only the locate line itself is shown relative to the locator. Thus, an operator is provided with a limited view of the overall environment.

Another issue specific to locate points, in the context of the '008 Patent, is that the locator is unable to distinguish between the FLP, ahead of the transmitter, and the RLP, between the transmitter and the drill rig. Considerable confusion can arise if an operator incorrectly assumes which locate point has been found. More generally, the display is also limited to two dimensions, which can make it difficult for the operator to correctly visualize the overall drilling environment. Applicant submits that there remains a need for improvement.

The prior art includes other examples of systems for tracking an inground tool that transmit a dipole locating signal. One such example is U.S. Pat. No. 8,188,745, issued to Overby, et al (hereinafter the Overby Patent). While the Overby Patent discusses a technique for finding the location of the inground tool using a complex technique, it is critical of earlier prior art techniques, including the '008 patent, that are reliant on the use of locate points. Applicant, in contrast, recognizes that the FLP is particularly valuable in providing an indication of where an inground tool is headed.

Based on its critical treatment of prior art that utilizes the locate points, it is not surprising that the Overby Patent does not discuss how to find the locate points within the framework of its technique for finding the transmitter. As another concern, Overby attempts to model the entire dipole field such that positional determinations of the location of the transmitter are not independent events and must be based on a plurality of measurements of the dipole flux at different positions of cart receiver 100. While claim 1 of Overby implies that the position of a sonde can be determined based on a single flux measurements, Applicant submits that this is not enabled given that it is technically impossible to characterize an entire dipole field (the approach upon which Overby is predicated) based on a single point flux measurement. As still another concern, Overby must determine a reasonably accurate location for each flux measurement.

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

In one aspect of the disclosure, embodiments can include a walkover locator and associated methods for use in a system for tracking a transmitter that is carried by a boring tool for forming a borehole along an underground path within a region. The transmitter is configured for transmitting a single axis dipole electromagnetic locating signal with the dipole axis aligned along an axis of the transmitter and having a plane of symmetry that is orthogonal to and bisects the dipole axis such that the locating signal exhibits a pair of locate points at a surface of the ground, one of which is ahead of the transmitter and another one of which is behind the transmitter, the transmitter further includes an accelerometer for measuring a pitch orientation of the transmitter.

In one example embodiment based on the disclosure, the walkover locator includes a yaw sensor for measuring a yaw orientation of the walkover locator with respect to north and a triaxial antenna for receiving the dipole electromagnetic signal along three orthogonally arranged receiving axes to generate a set of flux components. A processor generates a relative yaw orientation characterizing a difference between the measured yaw orientation of the walkover locator and a reference yaw orientation of the transmitter and determines an actual position of at least one of the locate points relative to the walkover locator for any location of the walkover locator within a first region on one side of the plane of symmetry and a second region on an opposite side of the plane of symmetry based on at least one measured set of the flux components, the relative yaw orientation and the measured pitch orientation of the transmitter. In one feature, a display is driven by the processor to illustrate the relative positional relationship including the walkover locator and at least one of the locate points.

In another example embodiment based on the disclosure, the walkover locator includes a yaw sensor for measuring a yaw orientation of the walkover locator with respect to north and a triaxial antenna for receiving the dipole electromagnetic signal along three orthogonally arranged receiving axes to generate a set of flux components. A processor generates a relative yaw orientation characterizing a difference between the measured yaw orientation of the walkover locator and a reference yaw orientation of the transmitter and determines a relative positional relationship between the walkover locator and each one of the locate points for any location of the walkover locator within a first region on one side of the plane of symmetry and a second region on an opposite side of the plane of symmetry based on at least one measured set of the flux components, the relative yaw orientation and the measured pitch orientation of the transmitter. A display is driven by the processor to illustrate the relative positional relationship including the walkover locator and both of the locate points. A display is driven by the processor to display the relative positional relationship including the walkover locator and both of the locate points.

In still another example embodiment based on the disclosure, a processor generates a relative yaw orientation characterizing a difference between the measured yaw orientation of the walkover locator and a reference yaw orientation of the transmitter and determines a first relative positional relationship between the walkover locator and the transmitter in three dimensions and a second relative positional relationship between the walkover locator and at least one of the locate points in at least two dimensions for any location of the walkover locator within a first region on one side of the plane of symmetry of the dipole electromagnetic locating signal and a second region on an opposite side of the plane of symmetry based on at least one measured set of the flux components, the relative yaw orientation and the measured pitch orientation of the transmitter. In one feature, a display is driven by the processor to display the first relative positional relationship and the second relative positional relationship including the walkover locator, at least one of the locate points and the transmitter.

In another aspect of the disclosure, embodiments include a display that can form part of a system for tracking a transmitter that is carried by a boring tool for forming a borehole along an underground path, the transmitter includes at least one accelerometer for measuring a pitch orientation of the transmitter and is configured for transmitting a single axis dipole electromagnetic locating signal having a dipole axis along which a transmitter axis of the transmitter is aligned and having a plane of symmetry that is orthogonal to and bisects the dipole axis, such that the locating signal exhibits a pair of locate points at a surface of the ground, one of which is ahead of the transmitter and another one of which is behind the transmitter.

In one example embodiment based on the disclosure, the display includes a processor that is configured to determine an actual position of at least one of the locate points relative to the walkover locator for any location of the walkover locator within a first region on one side of the plane of symmetry and a second region on an opposite side of the plane of symmetry based on at least one measured set of the flux components, the relative yaw orientation and the measured pitch orientation of the transmitter. A display screen can be driven by the processor to illustrate the relative positional relationship including the walkover locator and at least one of the locate points.

In another aspect of the disclosure, embodiments can include a walkover locator that forms part of a system for tracking a transmitter that is carried by a boring tool for forming a borehole along an underground path. The transmitter includes at least one accelerometer for measuring a pitch orientation of the transmitter and is configured for transmitting a single axis dipole electromagnetic locating signal with the dipole axis aligned along an axis of the transmitter such that the locating signal exhibits a pair of locate points at a surface of the ground, one of which is ahead of the transmitter and another one of which is behind the transmitter.

In one example embodiment based on the disclosure, the walkover locator includes a triaxial antenna for receiving the dipole electromagnetic signal along three orthogonally arranged receiving axes to generate a set of flux components and a GPS receiver having a GPS output for generating positional coordinates that identify a current position of the walkover locator. A processor is configured tσ(i) identify the front locate point and the rear locate point and record a front locate point GPS position and a rear locate point GPS position, respectively, based on the measured flux components and the GPS output and (ii) determine coordinates associated with an overhead point above the transmitter and between the front locate point and rear locate point based on the front locate point GPS position, the rear locate point GPS position and the measured pitch. In one feature, an embodiment can include a yaw sensor for distinguishing between the front locate point and the rear locate point. In another feature, the front locate point and the rear locate point are distinguished based on at least one previous positional determination.

In another example embodiment based on the disclosure, the walkover locator includes a triaxial antenna for receiving the dipole electromagnetic signal along three orthogonally arranged receiving axes to generate a set of flux components and a GPS receiver having a GPS output for generating positional coordinates that identify a current position of the walkover locator. A processor is configured to (i) identify the front locate point and the rear locate point and record a front locate point GPS position and a rear locate point GPS position, respectively, based on the measured flux components and the GPS output (ii) determine coordinates associated with a transmitter yaw line extending between the front locate point and rear locate point based on the front locate point GPS position and the rear locate point GPS position, (iii) measure the locating signal to determine a first component of the current position of the walkover locator along the transmitter yaw line with reference to the GPS output and read a current set of GPS coordinates from the GPS receiver to determine a second component of the current position in a direction that is laterally offset from the transmitter yaw line for providing guidance, in conjunction with the measured pitch, to move the walkover locator to at least one of an overhead point at the surface of the ground directly above the transmitter and overhead line such that the second component is more accurate than determining a lateral offset from the transmitter yaw line using just the locating signal.

In a continuing aspect of the present disclosure, an embodiment of a portable locator apparatus forms part of an inground locating system is configured for locating a transmitter that transmits an electromagnetic locating signal from underground.

In an example embodiment based on the disclosure, the portable locator apparatus includes a locator housing and a triaxial antenna supported by the housing for receiving the electromagnetic locating signal to generate a locating signal output for tracking the transmitter. A GPS module is supported by the housing and includes a GPS antenna that is at a predetermined offset from the triaxial antenna with reference to the housing. The GPS module generates a GPS position output that characterizes a GPS position of the GPS antenna. A yaw sensor produces a yaw orientation output and a processor determines a location of the triaxial antenna in earth-based coordinates at least based on the predetermined offset, the yaw orientation and the GPS position of the GPS antenna.

In still another aspect of the present disclosure, embodiments of a walkover locator form part of a system for tracking a transmitter that is carried by a boring tool for forming a borehole along an underground path.

In an example embodiment based on the disclosure, the transmitter is configured for measuring a pitch orientation of the transmitter and for transmitting a dipole locating signal, characterizing the measured pitch orientation. The dipole locating signal includes a dipole axis along which a transmitter axis of the transmitter is aligned. The walkover locator includes a triaxial antenna for receiving the dipole locating signal along three orthogonally arranged receiving axes to generate a set of flux components. The walkover locator further includes a processor configured to measure the flux components and generate a flux pitch of the dipole locating signal and, responsive to the flux pitch of the dipole locating signal matching the measured pitch orientation of the transmitter, determine a yaw heading of the transmitter relative to a current orientation of the walkover locator.

In another example embodiment based on the disclosure, the transmitter includes at least one accelerometer for measuring a pitch orientation of the transmitter and is configured for transmitting a single axis dipole electromagnetic locating signal with the dipole axis aligned along an axis of the transmitter and having a plane of symmetry that is orthogonal to and bisects the dipole axis, such that the locating signal exhibits a pair of locate points at a surface of the ground, one of which is ahead of the transmitter and another one of which is behind the transmitter. The walkover locator includes a yaw sensor for measuring a yaw orientation of the walkover locator with respect to north and a triaxial antenna for receiving the dipole electromagnetic signal along three orthogonally arranged receiving axes to generate a set of flux components. A GPS unit outputs GPS readings that specify a current position of the walkover locator. A processor is configured (i) to determine an actual position at least of an overhead point directly above the transmitter at the surface of the ground in a first locating mode for any location of the walkover locator within a first region on one side of the plane of symmetry and a second region on an opposite side of the plane of symmetry at least based on the set of flux measurements and the measured yaw orientation wherein the first locating mode is unstable in the plane of symmetry and (ii) to determine the actual position of the overhead point in a second locating mode based at least on the GPS readings and the set of flux measurements with the walkover locator in the plane of symmetry wherein the second locating mode is stable in the plane of symmetry.

### BRIEF DESCRIPTIONS OF THE DRAWINGS

Example embodiments are illustrated in referenced figures of the drawings. It is intended that the embodiments and figures disclosed herein are to be illustrative rather than limiting.

FIG. 1 is a diagrammatic elevational view illustrating the operation of a system embodiment and locator embodiment produced in accordance with the present disclosure.

FIG. 2 is a block diagram illustrating the locator embodiment of FIG. 1.

FIG. 3 is a diagrammatic view, in perspective, of a master coordinate system reference framework showing aspects of locator and transmitter coordinate axes positioned therein.

FIG. 4 is another diagrammatic view, in perspective, of the master coordinate system reference framework showing aspects of the locator and transmitter positioned therein with the locator coordinate axes subject to two rotations.

FIG. 5 is a diagrammatic view, in elevation, of the master coordinate system reference framework showing aspects of the locator and transmitter positioned therein with the locator coordinate axes subject to the rotations and from a perspective such that Y_{T} and Y′_{L} axes appear as points.

FIG. 6 is a diagrammatic view, in perspective, of the master coordinate system framework showing the rotated axes of FIGS. 4 and 5, but taken from a perspective such that X_{T} and X′_{L} axes appear as points.

FIG. 7 is a diagrammatic view, in perspective, of the master coordinate system framework taken from the same perspective as that of FIG. 6, but with the locator based coordinate system subject to an additional rotation about the X′_{L} axis.

FIG. 8a is a diagrammatic illustration in two dimensions showing details of the relationship between the locator and the transmitter subject to the rotation of FIG. 7 in an X″/Z″ plane.

FIG. 8b is a diagrammatic view, in elevation, illustrating the incorporation of topographical information for use in display screens of the present disclosure

FIG. 9 is a flow diagram illustrating an embodiment of a method for the operation of the locator of the present disclosure or other suitable component of the system.

FIG. 10 is an illustration of a screen shot showing an embodiment of a menu in accordance with the present disclosure for setting transmitter yaw orientation.

FIG. 11a is a flow diagram illustrating an embodiment of a method for determining an updated transmitter yaw orientation in accordance with the present disclosure based on a selection that is provided in the menu of FIG. 10.

FIG. 11b is screen shot illustrating an embodiment for guiding an operator to move a locator to a plane of symmetry of the dipole field.

FIG. 12 is an illustration of a screen shot showing an embodiment of a locating display in accordance with the present disclosure in a plan view locating display mode which shows a front locate point (FLP) in relation to the transmitter.

FIG. 13 is an illustration of an embodiment of a dropdown display element selection that can be presented in response to a selection in the locating display of FIG. 12, showing different display elements that are available for operator selection for presentation as part of a current locating display mode.

FIG. 14 is an illustration of an embodiment of another dropdown display element selection that can be presented in response to a selection in the locating display of FIG. 12, showing different locating display modes are available for operator selection for presentation.

FIG. 15 is a diagrammatic illustration of a custom hybrid 3D locating display mode that is available responsive to operator selections in the dropdown menus of FIGS. 13 and 14.

FIG. 16 is a diagrammatic illustration of a custom hybrid locating display mode with 3D preferred that is available responsive to operator selections in the dropdown menus of FIGS. 13 and 14.

FIG. 17 is a diagrammatic illustration of a custom hybrid locating display mode with plan view preferred that is available responsive to operator selections in the dropdown menus of FIGS. 13 and 14.

FIG. 18 is a flow diagram which illustrates an embodiment of a method for operating a walkover locator in a GPS locating mode as well as switching between a 3D locating mode and the GPS locating mode in accordance with the present disclosure.

FIG. 19 is a screenshot illustrating one embodiment of a display for indicating that the walkover locator is switching to a GPS locating mode.

FIG. 20 is a diagrammatic view, in elevation, illustrating a transmitter in relation to a sloped ground surface and a number of relevant variables.

FIG. 21a is a flow diagram which illustrates another embodiment of a method for operating a walkover locator in a GPS locating mode in accordance with the present disclosure.

FIG. 21b is a flow diagram which illustrates yet another embodiment of a method for operating a walkover locator in a GPS locating mode in accordance with the present disclosure.

FIG. 22 is a screen shot that illustrates a non-limiting embodiment of directional indications that can be provided for operator guidance.

FIG. 23 is a diagrammatic illustration in a plan view showing components of walkover locator position in relation to a transmitter yaw line defined between the FLP and a rear locate point (RLP).

FIG. 24 is a screen shot that illustrates an embodiment of the display of an overhead point.

FIG. 25 is a flow diagram illustrating an embodiment of a method for determining the position of a locating antenna in earth-based coordinates.

### DETAILED DESCRIPTION

The following description is presented to enable one of ordinary skill in the art to make and use the invention and is provided in the context of a patent application and its requirements. Various modifications to the described embodiments will be readily apparent to those skilled in the art and the generic principles taught herein may be applied to other embodiments. Thus, the present invention is not intended to be limited to the embodiments shown, but is to be accorded the widest scope consistent with the principles and features described herein including modifications and equivalents. It is noted that the drawings are not to scale and are diagrammatic in nature in a way that is thought to best illustrate features of interest. Descriptive terminology may be adopted for purposes of enhancing the reader's understanding, with respect to the various views provided in the figures, and is in no way intended as being limiting.

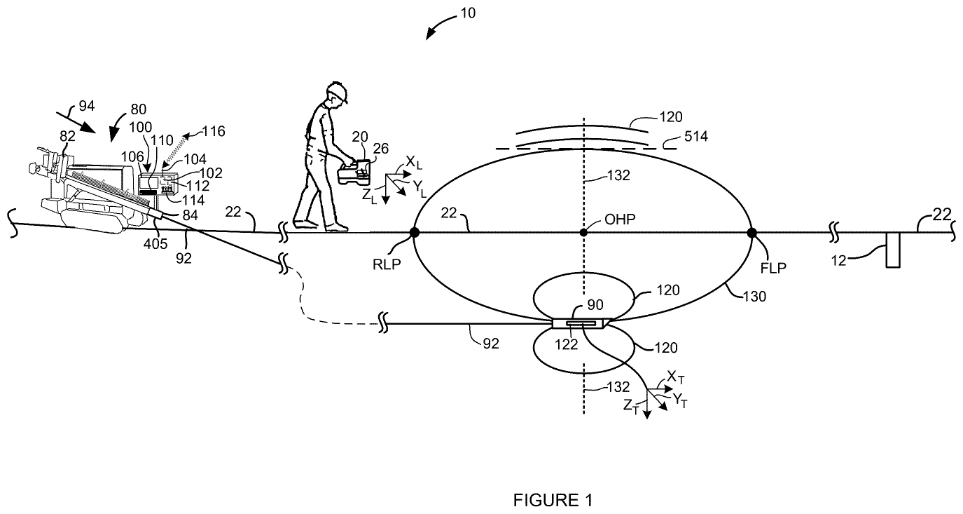

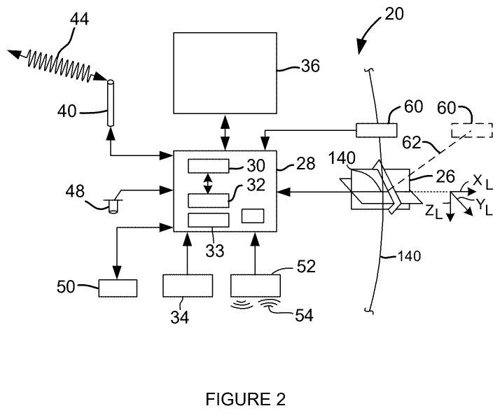

Turning now to the drawings, wherein like items may be indicated by like reference numbers throughout the various figures, attention is immediately directed to FIG. 1, which illustrates one embodiment of a system for performing an inground operation, generally indicated by the reference number 10. By way of example, the objective can be to drill to a pit 12 from which the drill rig will use the drill string to pull back a utility cable. The system includes a portable device 20, which may be referred to interchangeably as a locator or walkover locator, that is shown being held by an operator above a surface 22 of the ground as well as being shown in the form of a block diagram in FIG. 2. While the surface of the ground is shown as level for purposes of illustrative clarity, it is noted that this is not a requirement. While only limited inter-component cabling may be shown within device 20 in order to maintain illustrative clarity, all necessary cabling is understood to be present and may readily be implemented by one having ordinary skill in the art in view of this overall disclosure. Device 20 includes a triaxial antenna 26 measuring three orthogonally arranged components of magnetic flux that are fixed in relation to the frame or housing of the walkover locator. In the present example, an X_{L} axis extends forward, a Y_{L} axis extends to the right of the locator and a Z_{L} axis extends down, although this is not limiting and any suitable arrangement of orthogonal axes can be used. While these axes are shown spaced away from antenna 26 due to illustrative constraints, it is understood that the origin of the axes is centered on antenna 26. For subsequent reference, it is noted that these locator axes match the axes of the well-known NED (North, East and Down) coordinate system when the X axis of the locator is oriented facing north and level. In this example, the NED coordinate system is a local coordinate system having its origin at the center of the triaxial locating signal antenna with its X axis facing north, its Y axis facing east and its Z axis facing down. It should be appreciated that the origin of the NED coordinate system can be located at any suitable position. One embodiment of a useful antenna cluster contemplated for use herein is disclosed by U.S. Pat. No. 6,005,532 which is commonly owned with the present application and is incorporated herein by reference. Details with respect to the embodiment of the antenna utilized herein will be provided at an appropriate point hereinafter. Antenna cluster 26 is electrically connected to an electronics section 28 including at least one processor 30, memory 32 and any other necessary componentry including, for example, antenna drivers and analog to digital converters. In an embodiment, a quadrature phase (i.e., I/Q) demodulator 33 can be provided. As is well known in the art, the latter should be capable of generating a frequency that is at least as high as the highest frequency of interest. A tilt sensor arrangement 34 may be provided for measuring gravitational angles (i.e., pitch and roll) from which the components of flux in a level coordinate system may be determined. An appropriate tilt sensor includes, by way of non-limiting example, a triaxial accelerometer which can be a MEMS triaxial accelerometer.

Device 20 can further include a graphics display 36 positioned on top of the device for viewing by the operator and a telemetry antenna 40. The latter can transmit or receive a telemetry signal 44 for data communication with the drill rig. It should be appreciated that graphics display 36 can be a touch screen in order to facilitate operator selection of various buttons that are defined on the screen and/or scrolling can be facilitated between various buttons that are defined on the screen to provide for operator selection. Such a touch screen can be used alone or in combination with an input device 48 such as, for example, a trigger button. The latter can be used without the need for touch functionality in the display screen. Moreover, many variations of the input device may be employed and can use scroll wheels and other suitable forms of selection device either currently available or yet to be developed. Other components may be added as desired such as, for example, a yaw sensor 50 to aid in heading determination of device 20. In an embodiment, the yaw sensor can be a magnetometer. In another embodiment, the yaw sensor can be a gyroscope. In some embodiments, a gyroscope can include one or more rate gyros. Ultrasonic transducers 52 emit and then receive reflected ultrasonic signals 54 for measuring the height of the device above the surface of the ground. In some embodiments, device 20 can include a GPS unit 60 which can be a precision GPS providing for resolutions at centimeter or even sub-centimeter levels. In one embodiment, the antenna of the GPS unit can be in vertical alignment with locating signal antenna 26 to reduce offset errors by reducing the distance between these two antennas and minimizing horizontal offsets. In another embodiment, GPS functionality, which can include precision resolution, can be provided by a removably attachable GPS module such as described, for example, in commonly owned U.S. Pat. No. 11,067,700, filed on Aug. 27, 2018 and hereby incorporated by reference (hereinafter, the '700 patent). In the '700 patent, an offset 62 is introduced between triaxial antenna 26 and the antenna of GPS unit 60, which is diagrammatically shown in phantom using dashed lines. It should be appreciated that this offset can be thought of as predetermined or fixed even with respect to a GPS unit that is removably attachable, as is the case with the '700 patent. Details will be provided at an appropriate point below with respect to compensation for such an offset. Of course, co-location of a GPS antenna and locating signal antenna is difficult, at best, and such an offset can even be desirable, for example, for purposes of providing noise immunity. Thus the teachings herein are applicable to any design that exhibits an offset between the two antennas.

Referring to FIG. 1, system 10 further includes drill rig 80 having a carriage 82 received for movement along the length of an opposing pair of rails 84. An inground tool 90 is attached at an opposing end of a drill string 92, segments of which are shown for purposes of illustrative clarity. By way of non-limiting example, a boring tool is shown as the inground tool and is used as a framework for the present descriptions, however, it is to be understood that any suitable inground device may be used such as, for example, a reaming tool for use during a pullback operation or a mapping tool. Generally, drill string 92 is made up of a plurality of removably attachable drill pipe sections such that the drill rig can force the drill string into the ground using movement in the direction of an arrow 94 and retract the drill string responsive to an opposite movement. The drill pipe sections can define a through passage for purposes of carrying a drilling mud or fluid that is emitted from the boring tool under pressure to assist in cutting through the ground as well as cooling the drill head. Generally, the drilling mud also serves to suspend and carry out cuttings to the surface along the exterior length of the drill string. Steering can be accomplished in a well-known manner by orienting an asymmetric face of the boring tool for deflection in a desired direction in the ground responsive to forward, push movement which can be referred to as a “push mode.” Rotation or spinning of the drill string by the drill rig will generally result in forward or straight advance of the boring tool which can be referred to as a “spin” or “advance” mode.

The drilling operation can be controlled by an operator (not shown) at a control console 100 which itself includes a telemetry transceiver 102 connected with a telemetry antenna 104, a display screen 106, an input device such as a keyboard 110, a processing arrangement 112 which can include suitable interfaces and memory as well as one or more processors. A plurality of control levers 114, for example, control movement of carriage 82. Telemetry transceiver 102 can transmit or receive a telemetry signal 116 to facilitate bidirectional communication with portable device 20. In an embodiment, screen 106 can be a touch screen such that keyboard 110 may be optional.

Device 20 is configured for receiving an electromagnetic dipole locating signal 120 that is transmitted by a transmitter 122 that is supported by inground tool 90. In some embodiments, transmitter 122 can transmit multiple dipole signals such as, for example, a depth signal for determining depth and for locating purposes and a data signal for transmitting data such as, for example, orientation data and operational status as described in commonly owned U.S. Pat. No. 9,739,140, which is hereby incorporated by reference.

Information carried by the locating signal, using any suitable form of modulation, can include, but is not limited to position orientation parameters based on pitch and roll orientation sensor readings, temperature values, pressure values, battery status and the like. The pitch and roll orientation can be measured, for example, by one or more triaxial accelerometers. One suitable arrangement using MEMS triaxial accelerometers is described in U.S. Pat. No. 9,551,730, filed on Jul. 1, 2015, which is commonly owned with the present application and is hereby incorporated by reference. Device 20 receives the transmitter signals using antenna 26 and processes received signal 120 to recover the data. Transmitter 122 transmits signal 120 from a dipole antenna that is arranged having an elongated axis of symmetry at least approximately coaxial with an elongated axis of symmetry of inground tool 90. Accordingly, signal 120 is a dipole field having a dipole axis that is coaxial with the elongated axis of symmetry of the dipole antenna.

Referring to FIG. 1, dipole locating signal 120 defines a number of distinct points as measured by device 20. At a front locate point, FLP, a particular flux line 130 passes vertically through the surface of the ground. In other words, a tangent to flux line 130 is vertical at the FLP, given that the flux line is curved. A portion of a flux line 140 is also shown in FIG. 2 passing through antenna 26. It is noted that the vertical orientation of the flux line is identified at the location of antenna 26 wherein the locator supporting the antenna can be held above the surface of the ground or placed on the ground. Given that ground surface 22 is assumed to be level, flux lines 130 and 140 are measured as normal to the ground surface. A rear locate point RLP (FIG. 1) is positioned on an opposite side of transmitter 122 toward the drill rig at the same distance from the transmitter as the FLP because the inground transmitter, like the surface of the ground, is level. If the transmitter is pitched, the FLP and the RLP will move such that they are no longer equidistant from the transmitter. As another characteristic of dipole signal 120, all of the flux lines are parallel in a plane of symmetry 132 (indicated using dashed lines) that bisects the dipole antenna in transmitter 122. With the transmitter in a level orientation, the flux lines in the plane of symmetry are measured as being horizontal when the transmitter is level (i.e., not pitched). Thus, directly above transmitter 122 and given that the transmitter is horizontal, the flux lines are measured as being horizontal at an overhead point (OHP) which is designated as OHP. In this case, the OHP may be referred to as a locate line point or LLP. If one finds the FLP and the RLP, the LLP and OHP are found in the plane of symmetry on a line drawn between the locate points and one-half way therebetween, again assuming that the transmitter is not pitched. Further, the LLP and OHP are contained by a locate line (LL) and an overhead line (OHL), both of which lines are normal to the view of the figure. Measured flux at the LL and the OHL is horizontally oriented. On the other hand, when the transmitter is pitched, the LLP as well as the LL are not directly above the transmitter but instead move ahead of or behind the OHP and OHL, dependent upon the sign and magnitude of the pitch. As such, the LLP and LL are not one-half way between the FLP and the RLP with non-zero pitch.

As will be seen, device 20 can identify the actual position of each of the FLP, RLP, LL, OHP, OHL and transmitter 122 relative to the current location of device 20. By way of comparison, it should be appreciated that the '008 Patent is unable to make determinations of the actual positions of the FLP and the RLP when the locator is laterally offset for the reasons discussed above. Also, it can be challenging to find the actual position of a point directly above the transmitter at the surface of the ground based on the teachings of the '008 Patent. While the LLP is coincident with the OHP when the transmitter is level, there are concerns with respect to finding the OHP or LLP even under the circumstance of a level transmitter. In particular, there is a low gradient of flux slope near the LLP/OHP with a level transmitter especially orthogonal to the transmitter axis. Therefore, it can be difficult to pinpoint the OHP or LLP with significant accuracy. Of course, this means that it is even more difficult to find the OHP when the transmitter is pitched and, in this case, the '008 offers no effective way to find the OHP. As a further concern, the locator is itself unable to distinguish between the FLP and the RLP in the context of the '008 Patent. The present Application, in contrast provides for localizing and displaying one or more of these actual positions, as well as automatically distinguishing between the FLP and the RLP. It is noted that the term “actual position” as used herein refers to determining the exact location (at least within the constraints of measurement error) of these various positions in relation to the locator (heading and distance at the surface of the ground), as limited only by unavoidable measurement error, in relation to the current position of device 20. Stated in another way, these positions can be defined, for example, in a locator-based coordinate system with the locator at the origin or a transmitter-based coordinate system with the transmitter at the origin, among other possibilities. By way of example, this means that the operator of device 20 can visualize any or all of the actual positions, for example, of the FLP, RLP and LLP from an offset position and/or direct a co-worker to these positions, if so desired. Applicant is unaware of any prior art device having such advanced capabilities. For example, these capabilities are not available in the aforedescribed '008 patent due to the curvature of the flux lines that are followed to the FLP and the RLP. It should also be appreciated that, in the present Application, the position of the transmitter is determined in three dimensions and the determination also includes specifying the pitch orientation and heading (yaw) of the transmitter.

Position determinations will be described in terms of a Cartesian coordinate system with coordinate axes denominated as X, Y and Z with the axes mutually oriented according to conventional aircraft Cartesian coordinate systems and having an origin at the center of the antenna of transmitter 122. It is noted that this X, Y, Z coordinate system may be referred to as a Master Coordinate System (MCS). Relevant parameters include:
Position coordinates of the dipole (three parameters: X_{T}, Y_{T}, and Z_{T} in Cartesian coordinates) with an origin at the antenna in transmitter 122 that transmits dipole locating signal 120.
Orientation of the dipole (two parameters: pitch (θ_{T}) and yaw (β_{T})) Strength of the dipole (one parameter: dipole moment (μ)).
Position of the electromagnetic dipole field sensor(s) (i.e., the position of the locator and, more particularly, antenna 26, specified by three parameters: X_{L}, Y_{L}, and Z_{L} in Cartesian coordinates).
Orientation of the magnetic-field sensor(s) (three parameters: pitch (ϕ), yaw (β_{L}) and roll.

This listing represents 12 parameters, however, known values can include the orientation of the magnetic-field sensor (i.e., antenna 26 of FIG. 2), the orientation (i.e., pitch and yaw) of the dipole, and the dipole strength. The pitch of the transmitter can be recovered from the locating signal. The tilt (i.e., pitch and roll) of the locator are measured by tilt sensor 34 while the dipole strength can be determined in a calibration procedure prior to the start of the inground operation. In this case, the number of unknowns is reduced to six. Because only the relative position of the dipole with respect to the locator is necessary to determine, the number of unknowns is reduced to three. The transmitter is centered on the origin of the transmitter Cartesian coordinate system with the origin at the center of antenna 122 (FIG. 1), an X_{T} axis facing forward, a Yr axis extending to the right from the transmitter when facing forward and a Z_{T} axis extending downward. Accordingly, with the measurement of three orthogonal components of the magnetic field (Bₓ, B_{y} and B_{z}) in locator-based coordinates at the locator, there are three knowns and three unknowns. However, because the dipole magnetic field is a non-linear function of the relative position, there can be multiple position solutions that produce the same magnetic field. Resolving this ambiguity will be addressed below.

### Analytical Framework for Localization of Actual Dipole Field Positions

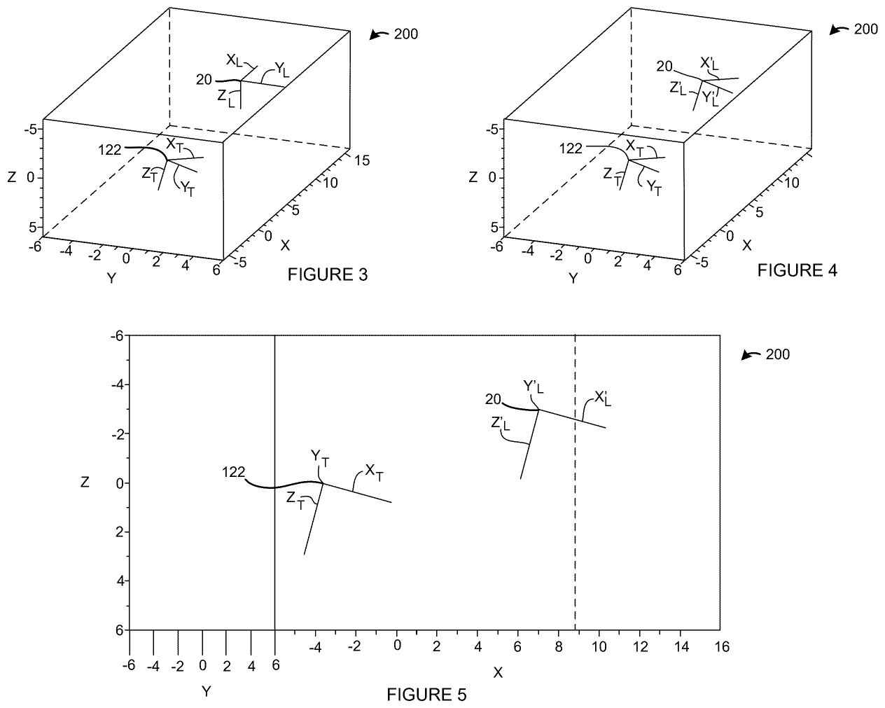

The discussions which follow immediately hereinafter describe, in detail, an analytical framework for determining the actual positions of important points or features of interest relative to portable device 20 based on measurements of the dipole field by the portable device. These points include the FLP, the RLP, the LLP, the LL, the OHL and the OHP. With this in mind, attention is immediately directed to FIG. 3, which is a diagrammatic view, in perspective, of the master coordinate system (MCS) initially introduced in the discussions above. A coordinate system (MCS) box or reference framework is shown, generally indicated by the reference number 200. The X, Y and Z master coordinate system values are designated along edge margins of the MCS box. It is noted that the specific orientation of the axes of the MCS can be arbitrary since this system serves as a framework for purposes of specifying the actual location of locator 20 relative to transmitter 122. It is also noted that the locator-based coordinate axes are shown as parallel to corresponding axes of the MCS for convenience, although this is not a requirement, such that flux measurements taken by the locator in locator-based coordinates are aligned with corresponding axes of the MCS. Accordingly, in the present example, β_{L}=0 degrees and θ_{L}=0 degrees referenced to the MCS with the locator positioned at MCS (10,1,−3). For the transmitter, β_{T}=30 degrees, while θ_{T}=−15 degrees referenced to the MCS with the transmitter positioned at the MCS origin (0,0,0).

Applicant recognizes that a solvable case is presented when the orientations of both the transmitter and the locator are known. As seen in FIG. 3, this can be represented with transmitter 122 (i.e., the center of the dipole antenna) at the origin of the MCS, with dipole moment, μ, pitch (θ_{T}), and yaw (β_{T}). At the position of the locator, the measured magnetic field is:

$$\vec{B} = ( {B}_{x} , {B}_{y} , {B}_{z} ) \qquad EQN . ( 1 )$$

Turning now to FIG. 4 in conjunction with FIG. 3, the former illustrates MCS coordinate box 200 in the same perspective as FIG. 3. Applicant recognizes that the problem can be transformed into a two-dimensional problem by rotation of the locator coordinate system and associated fluxes by β_{T} and θ_{T} so that the rotated locator X_{L} (i.e., X′_{L}) axis is parallel to the dipole magnetic moment (i.e., the transmitter X_{T} axis). That is, the locator-based axes are rotated by β_{T} about axis Z_{L} and by θ_{T} about axis Y_{L}, the result of which is shown in FIG. 4 having axes X_{L}, Y′_{L} and Z′_{L} subject to two rotations. Thus, the rotated locator axes have a pitch and yaw identical to the corresponding axes of the transmitter.

FIG. 5 is a diagrammatic two-dimensional view, in elevation, of MCS coordinate box 200 taken from a perspective along the Y′_{L} and Y_{T} axes such that these axes appear as points and which foreshortens the MCS Y axis as compared to the MCS X axis. This figure illustrates that the X′_{L} axis is now parallel to the X_{T} axis while the Z axis is now parallel to the Z_{T} axis.

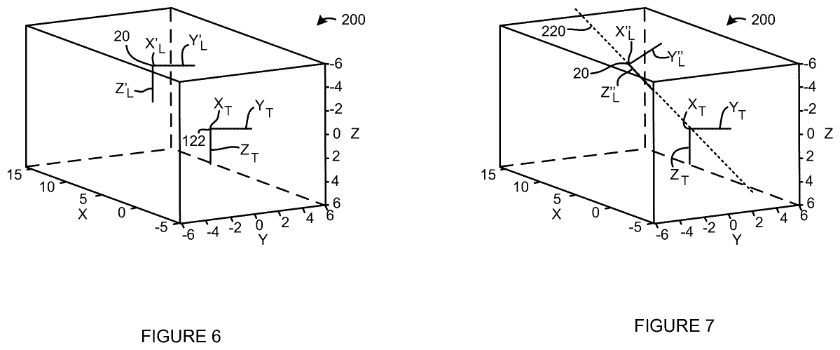

FIG. 6 is a diagrammatic view, in perspective, of MCS coordinate box 200 viewed in the direction of the X_{T} and X′_{L} axes such that these axes appear as points and after the rotations by β_{T} about axis Z_{L} and by θ_{T} about axis Y_{L}, as described above.

FIG. 7 is a diagrammatic view, in perspective, of MCS coordinate box 200 taken from the same perspective as the view of FIG. 6. The locator-based coordinate system is then rotated about the X′_{L} axis until the Z′_{L} axis intersects the X axis of the transmitter. For consistency of notation, the resultant axes are indicated as X″_{L}, Y″_{L} and Z″_{L} (which may be referred to as the double primed locator coordinate system) though the X″_{L} axis is the same as the X′_{L} axis. Accordingly, the Z″_{L} axis is contained by or parallel to a plane 220 which is visible edgewise in the present figure as a dotted line. Plane 220 contains the locator X″_{L} axis and the transmitter X_{T} axis. Plane 220 defines the 2D geometry of the problem. Given that plane 220 contains the X axis, for a flux measurement taken at any point within the plane there is no transverse flux component. That is, only two orthogonal flux components are present, both of which are measureable within plane 220. Accordingly, in the double primed locator coordinate system, the only unknown values are designated as B″ₓ along the X″_{L} axis and B″_{z} along the Z″_{L} axis. The flux component in the transverse direction of Y″_{L} is known to be always equal to zero, thereby eliminating one unknown.

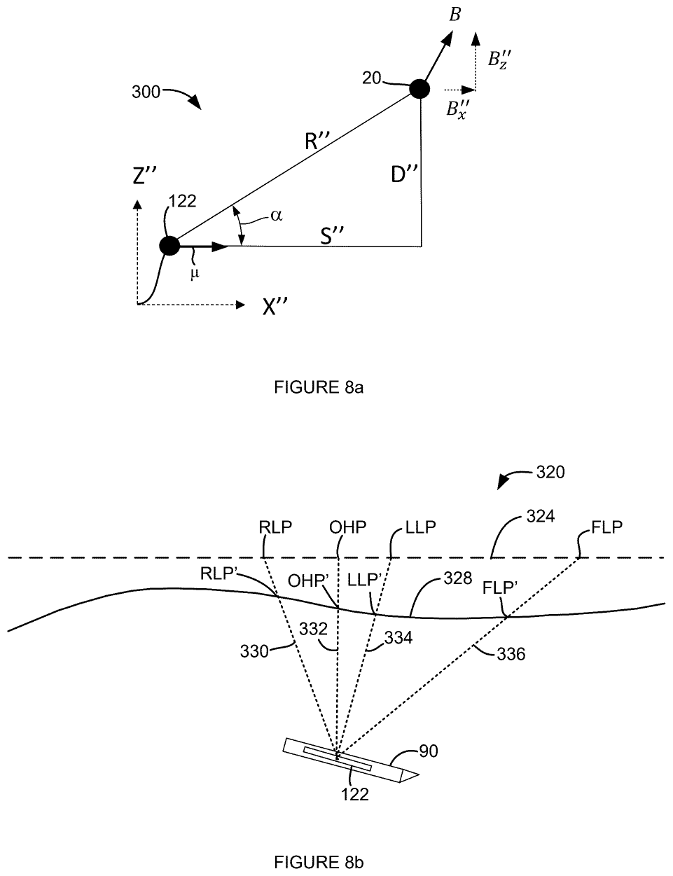

FIG. 8a is a diagrammatic illustration, generally indicated by the reference number 300, showing the X″, Z″ plane including locator 20, transmitter 122 with dipole moment u and a flux B at the locator comprised of flux components B″ₓ and B″_{z} within the plane. Horizontal distance from the transmitter is given by the variable S″ while vertical distance from the transmitter is given by the variable D″ which is parallel to the dipole moment and radial distance is given by the variable R″. The two-dimensional framework in FIG. 8a provides a closed-form solution for the relative position of the dipole with respect to the locator:

$${R}^{″} = {\{ \frac{\vert - {B}_{x}^{″} + \sqrt{9 {( {B}_{x}^{″} )}^{2} + 8 {( {B}_{z}^{″} )}^{2}} \vert}{4} \}}^{- 1 / 3} \qquad ( EQN . 2 )$$

$$α = {tan}^{- 1} [ \frac{{B}_{z}^{″}}{( 1 / {{R}^{″}}^{3} ) + {B}_{x}^{″}} ] \qquad ( EQN . 3 )$$

$${S}^{″} = {R}^{″} cos ( α ) \qquad ( EQN . 4 )$$

$${D}^{″} = {R}^{″} sin ( α ) \qquad ( EQN 5 )$$

Where R″ is the total distance between the dipole and locator, S″ is the component of R″ parallel to the X″_{L} axis, and D″ is the component of R″ parallel to the Z″ axis. The final step is to transform the vector back to the MCS to obtain the relative position of the locator with respect to the dipole:

$$[ x , y , z ] = M ( - {θ}_{T} , - {β}_{T} ) * M ( - φ ) * [ {S}^{″} , 0 , {D}^{″} ] \qquad ( EQN . 6 )$$

where M(θ_{T},β_{T}) is a rotation operator that transforms a vector from the MCS to the single prime reference frame in which the X′_{L} axis is aligned with the dipole moment that has pitch θ_{T} and yaw β_{T} and the Y′ axis is parallel to the horizontal plane of the MCS. M(φ) of Equation 6 is another rotation operator that rotates the locator coordinate system (primed in FIG. 6) about its X″ axis such that its Z″ axis intersects the X_{T} axis of the dipole. The rotation operator, M(θ_{T},β_{T}), is straightforward because the pitch and yaw of the dipole are known. The rotation operator, M(φ), can be determined by noting that the magnetic field from the dipole at the locator is in the plane defined by the X_{T} and X′_{L} axes, i.e. if the locator's primed coordinate system is rotated about its X′ axis such that its Z″ axis intersects the X_{T} axis of the dipole, then there is no Y component to the magnetic field. Therefore, the rotation angle, φ, is given by:

$$φ = {tan}^{- 1} ( \frac{{B}_{y}^{′}}{{B}_{z}^{′}} ) \qquad ( EQN . 7 )$$

where B′_{y} and B′_{z} are the magnetic-field components in the Y″ and Z′ directions of the locator, i.e. its axes after rotation by M(θ_{T},β_{T}).

The relative position solution given by Equation 6 and the procedure described in detail above is valid only if the locator, in the 2D frame of reference shown in FIG. 8a, is on the +X″ half of the reference frame with respect to the dipole. If the sensor (i.e., antenna 26) is on the −X″ half of the reference frame, the procedure described above will produce a solution in which the calculated coordinates are the negative of the correct coordinates, i.e. (−x,−y,−z). The procedure for determining the correct coordinates when the locator is on the −X″ half of the reference frame is identical to the procedure above, but with the transmitter pitch, θ, and yaw, β, replaced by −θ and (β+180 degrees), respectively, and the measured magnetic field, \vec{β}, replaced by −\vec{β}.

In an embodiment, relative coordinates can be determined by carrying out both procedures, assuming that the locator is on both the +X″ and −X″ halves of the reference frame, and noting that the vast majority of situations involve the locator above the transmitter, so a solution with the locator below the transmitter can usually be discarded in favor of the correct solution. In some embodiments, the position of the locator can be tracked from one relative position determination to the next to thereby monitor which half of the double primed reference frame the locator is in. Once the position and orientation of the transmitter is known, the positions of the FLP, RLP and LL can be determined. It is noted that these positions can be determined irrespective of whether the surface of the ground is level. Assuming that the transmitter is at MCS position (0,0,0), is pointing in the +X direction, has a pitch of θ, and the ground is a horizontal plane at coordinate Z_{g} in the MCS. The position of the FLP along X (since Y=0) is then:

$${X}_{FLP} = - Z [ 3 sin ( θ ) - \sqrt{{8 [ cos ( θ ) ]}^{2} + {9 [ sin ( θ ) ]}^{2}} ] / [ 4 cos ( θ ) ] \qquad ( EQN . 8 )$$

The location of the RLP, again given that Y=0, is:

$$i {X}_{RLP} = - Z [ 3 sin ( θ ) + \sqrt{{8 [ cos ( θ ) ]}^{2} + {9 [ sin ( θ ) ]}^{2}} ] / [ 4 cos ( θ ) ] \qquad ( EQN . 9 )$$

The location of the LLP, at the intersection of a vertical plane containing the X axis and the LL, is:

$${X}_{LLP} = Z [ 3 cos ( θ ) - \sqrt{{8 [ sin ( θ ) ]}^{2} + {9 [ cos ( θ ) ]}^{2}} ] / [ 2 sin ( θ ) ] \qquad ( EQN . 10 )$$

Thus, the LLP is at coordinates (X_{LLP}, 0, Z_{g}), while the LL extends through the LLP at the surface of the ground and normal to a vertical plane that contains the X axis (i.e., the center axis of the dipole field). It is noted that the coordinates of the OHP are (0, 0, Z_{g}).

FIG. 8b is a diagrammatic view, in elevation, and generally indicated by the reference number 320, showing a level ground surface 324 as a dashed line in relation to an uneven ground surface 328 and further in relation to an uneven ground surface as well as inground tool 90. It is noted that Equations 8-10 apply to flat, level terrain 324 but the results can be readily be extended to uneven terrain 328. In this regard, it should be appreciated that the RLP, OHP, LLP, and FLP are determined based on straight lines starting at the center of transmitter antenna 122 as illustrated in FIG. 8b. Accordingly, for at least generally flat, level terrain 324, the locations of the RLP, OHP, LLP, and FLP can be determined using the equations above, but if the terrain is uneven as illustrated by uneven surface 328, it is only necessary to determine intersections of each of lines 330, 332, 334 and 336 that define the RLP, FLP, LLP, and OHP with the topography and designated as RLP′, FLP′, LLP′ and OHP′. Such topography can be readily obtained using a terrain mapping device, such as for example, a survey grade GPS device, other survey device or the planning tool described in commonly owned U.S. Pat. No. 11,149,539 entitled DRILL PLANNING TOOL FOR TOPOGRAPHY CHARACTERIZATION, SYSTEM AND ASSOCIATED METHODS, issued on Oct. 19, 2021 and hereby incorporated by reference.

In view of the foregoing, it should be appreciated that the actual positions of the FLP, RLP, LL, LLP, OHL and OHP are identified relative to the locator in the master coordinate system with no need for the operator to actually walk to those positions in doing so with only a requirement that the initial reference direction is sufficiently correct, which is submitted to be straightforward. In contrast, the technique of the '008 patent requires the operator to walk all the way to one of the locate points at a time to identify its actual position and is unable to distinguish which locate point has been found.

### Method of Application of the Analytical Framework

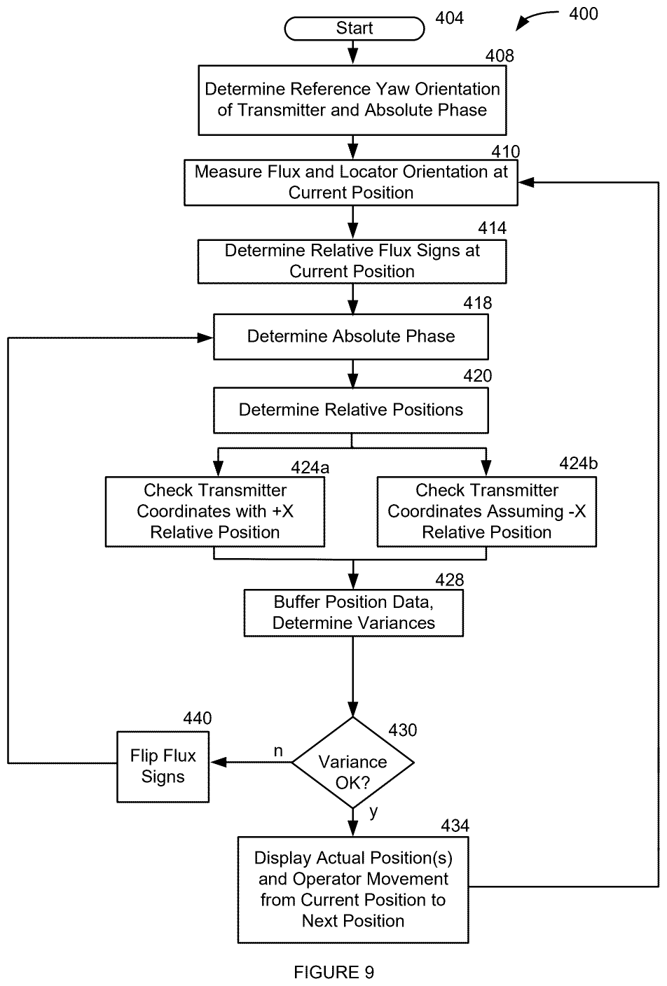

Attention is now directed to a detailed discussion of one or more embodiments of the application of the analytical framework described above for determining the actual positions of at least the FLP, the RLP, the LL, the OHP, the OHL and transmitter 122 relative to the current location of device 20. Accordingly, FIG. 9 is a flow diagram illustrating an embodiment of a method for the operation of locator 20, generally indicated by the reference number 400. For purposes of convenience, method 400 may be referred to hereinafter as a 3D locating mode. The method begins at 404 and operation proceeds to 408. The method relies on knowledge of the initial orientation (pitch, roll and yaw) of both the locator and the transmitter. With regard to the locator, pitch and roll orientation can be measured based on tilt sensor 34 (FIG. 2). With regard to the transmitter, accelerometer readings can characterize the roll and pitch orientations, as discussed above. Determination of the yaw orientation for either the locator or the transmitter can be accomplished by inclusion of a yaw sensor, such as a magnetometer or gyroscope. Given that it can be difficult to sense an external magnetic field from within the transmitter housed in a drill head, the initial or reference yaw orientation of the transmitter can be determined by several other techniques, as will be discussed at an appropriate point below.

In an embodiment, step 408 can also include a procedure to initially determine the absolute phase of the locating signal. The term “relative phase” refers to the phases of the three measured orthogonal flux components relative to one another. These relative phases should be either in-phase or 180 degrees out-of-phase with one another. The term “absolute phase” refers to the actual or correct phase of some measured component (βₓ, B_{y} or B_{z}) of the locating signal. The relative phases, as measured and assuming that there is no influence from noise, can be either in phase) (0° or out of phase) (180° with the actual/absolute phase of the measured flux component. In the procedure being described, the absolute phases are determined by measuring the relative phases of the locating signal with the dipole transmitter and the locator at known positions in relation to one another. The known positions establish the correct signs of the relative phases associated with the absolute phases. Relative phases can be measured, for example, using quadrature demodulation by I/Q demodulator 33 of FIG. 2. This procedure can be applied to determine the initial absolute phase prior to drilling and has the advantage that the absolute phases are known at one point in time and can be tracked thereafter. In other words, the locator flux measurements can be synchronized with the absolute phase of the transmitter using this technique. Of course, there can be relative clock drift between the transmitter and the locator going forward in time which can eventually require correction, although this can be negligible based on factors such as, for example, clock stability and the time duration of the inground procedure. It is noted that there is no requirement to establish the absolute phase at this point in method 400 since another procedure can later be applied to determine absolute phase or as a drift correction, as will be described at an appropriate point below.

Still referring to FIG. 9, operation proceeds to 410 which measures the flux of the locating signal for the current position of the locator relative to the transmitter. Accordingly, the phase and magnitude of each measured flux component can be determined at 410 by using a standard signal-processing technique such as, for example, quadrature (I/Q) demodulation using I/Q demodulator 33 of FIG. 2. As noted above, the phases that are determined by this demodulation are termed “relative phases” since they characterize the sign of the three phases relative to one another. In the presence of noise, the relative phases can be subject to a phase shift such that the relative phases are out of phase with the absolute phase of the locating signal, as will be discussed immediately hereinafter.

At 414, the mathematical signs for the relative phases of the measured orthogonal components of the locating field can be determined for a single flux measurement. By way of example, it is assumed that the phases (subject to noise) are determined relative to one another as +12°,−168°, and +12 for the X, Y, and Z components, respectively. The phases of all the components can be shifted by −12 degrees, making the relative phases 0°, 180°, and 0°. In this regard, there will be situations in which the magnitudes of one or more of the magnetic-field flux components are below the noise floor of the locator. Generally, a robust procedure in light of such a concern and which can be practiced without limitation is to set the phase of the largest-magnitude flux component to zero degrees, since such a large magnitude component will be accompanied by the most accurate measurement of phase. The measured phase of that largest component is then subtracted from the measured/demodulated relative phases of the other two components. In the present example, it is assumed that either Bₓ or B_{z} exhibits the largest magnitude such that one of these components is initially assigned to a phase of 0°. The other phases are then shifted by −12°. The relative phases can be determined in this manner essentially on a continuous basis. For example, the relative phases can be determined at least 25 times per second.

At 418, the absolute phase of the measured flux components can be determined. Recovering the absolute phase can be premised on the fact that that there are only two possibilities for the absolute phases as compared to the relative phases which are continuously determined. The relative phases either correspond correctly to the absolute phases, as determined at 414, or all of the relative phases require a phase shift of 180° (i.e., a sign change or inversion) to correctly correspond to the absolute phases. Taking the previous example of measured relative phases of 0°, 180°, and 0°, the other possibility for the absolute phases is 180°, 0° and 180°. In an embodiment, following at least one correct determination of absolute phases, the absolute phases can be tracked in a series of measurements during which the locator is moved relative to the transmitter. A procedure for tracking the signs of the absolute phases can involve:
1) Assume that measured B component magnitudes and relative phases for a current position of the locator and transmitter are: |Bₓ|, |B_{y}|, |B_{z}|, Φₓ, Φ_{y}, Φ_{z} from step 410, a positive phase (i.e.) 0° is assigned to the measured component having the largest magnitude;
2) For the other two flux components, if the phase of each component is within +/−90 degrees of the phase of the largest magnitude component, assign that component a positive sign, otherwise assign a negative sign; and
3) If the component with the largest magnitude for the current measurement was positive in the last measurement of the series, maintain the signs of all three components, otherwise change the sign of all three flux components.

With the result of the absolute phase determination in hand from step 418, operation moves to 420 which determines relative positions of the locator in relation to the transmitter using Equations (1)-(7) and the selected absolute phases. One of these positions may be the actual position, depending upon whether the correct set of phases has been selected as the absolute phase. In an embodiment, the position estimate needed for the solution procedure of Equations (1)-(7) can be the last-determined relative position of the transmitter with the absolute flux signs also based on the flux signs at the last-determined position, as described above. The relative positions that are determined should be mirror images of one another.

### Resolving Positional Ambiguity

Given that step 420 yields multiple position solutions, steps 424a and 424b are applied for purposes of resolving this positional ambiguity. As will be seen, the position solution for the incorrect set of phases will be unreasonable in some identifiable respect. By way of example, it is assumed that the dipole transmitter is stationary while the locator is moving in a horizontal plane, which is usually the case in HDD while performing locating. Step 424a tests the relative position solution that places the transmitter on the +X side of the master coordinate system while step 424b tests the relative position solution that places the transmitter on the −X (i.e., opposite) side of the coordinate system. For purposes of this discussion and with reference to FIG. 1, the transmitter is assumed to be at the origin with the +X side of the X axis ahead of the transmitter, opposite the transmitter with respect to the drill rig, and the −X side of the X axis behind the transmitter and extending toward the drill rig, Because it is nearly always the case that the locator is above the transmitter, a solution that yields a negative value for the Z coordinate of the locator can be discarded as unreasonable by either one of 424a or 424b. For a position result that is initially presumed to be correct, for example, based on the Z coordinate being positive and therefore reasonable, an additional procedure can be employed by method 400 to confirm that this position was determined based on the correct set of absolute phases, as will be described below.

At 428, the determined relative positions, associated flux values and signs used to determine the positions are buffered or saved. Once one of the relative positions is identified to represent the correct, unambiguous position of the locator, the identified relative position can be updated to an actual position, as the last position in a series of actual positions. Accordingly, buffered information is available for the current relative positions along with the series of determined actual positions corresponding to lateral movement of the locator relative to the transmitter. One or more statistical values can be determined at least for the relative position that is presumed to be correct. A suitable statistical value, for example, is the variance of the Z coordinate based on the value of the Z coordinate for the relative position that is presumed to be correct in conjunction with one or more (i.e., n) prior consecutive actual values of the Z coordinate terminating the series of buffered actual positions. It is noted that locator movement by an operator can reasonably be assumed as limited to lateral movement, since it is not difficult for an operator to hold the locator at an at least generally fixed distance above the surface of the ground during lateral movement. Given the power of modern processors, it should be appreciated that the position of the locator can be updated rapidly such that a given position in the series of actual positions is separated from a neighboring actual position by an incremental amount of movement. In some embodiments, this separation can be less than one inch for a typical walking speed at which the locator is moved laterally by an operator.

At 430 and having identified which one of the +X relative position or the −X relative position is presumed to be correct, a determination is made as to whether the correct signs have been used for the absolute flux. The test performed at step 430 can be based on Applicant's recognitions that (i) the coordinate value for the Z axis generally varies slowly from one determined position to the next determined position and (ii) the use of the incorrect set of absolute flux signs, for any given relative position, results in a value for Z that varies highly when compared to one or more prior determined positions. On the other hand, the variation in Z for the correct set of absolute flux signs results in a far lower, reasonable amount of variation when compared to one or more of the prior determined positions.

In an embodiment, based on the buffered information stored by step 428, step 430 can compare the variance of the Z coordinate for the presumed correct relative position to a threshold variance value. A suitable threshold variance value can be determined by testing in a variety of common environments. If this variance satisfies the comparison by not exceeding the threshold, the corresponding relative position solution is identified as the actual, correct position of the transmitter and buffered as such. It is noted that even for movement of the locator across a non-horizontal surface, the variance of the estimated Z position will be much larger for the incorrect set of phases unless the surface has a slope approaching or greater than roughly 45 degrees. Drilling on such steep terrain is an extraordinarily rare situation. It is noted that the use of the variance of the Z coordinate is not a requirement and any suitable combination of coordinate values and their variances can be used including, for example, σ(Z/X), σ(Y/X), σ(Z*Y/X), σ(Z)/σ(X) and σ(Y)/σ(X) where the standard deviation, or square root of the variance, of a parameter P is denoted as σ(P). Applicants recognize that this statistical technique becomes unstable when the locator (i.e., antenna 26 of FIG. 1) is in plane of symmetry 132 and the received signal at the locator is not subject to noise interference. The instability increases, however, when the received signal is subject to noise interference. That is, when the locator is within a limited distance or threshold distance from the plane of symmetry with the magnitude of this threshold distance dependent on the amount of noise interference. In either circumstance with or without noise interference, the operator can utilize a different locating technique in or near the plane of symmetry such as, for example, described in the '008 patent. Another highly accurate approach will be described at an appropriate point hereinafter based on an embodiment of locator 20 which includes a precision GPS unit 60 (FIG. 2). It is noted that the plane of symmetry is orthogonal to and bisects the dipole axis, dividing the dipole field into first and second regions on opposite sides of the plane of symmetry. The plane of symmetry is vertically oriented when the transmitter is level or not pitched and tilts when the transmitter is pitched. It is noted that an advanced technique will be described at an appropriate point below for switching between the 3D locating mode, currently being described, and an alternate mode that is stable in the plane of symmetry.

If the test at 430 is satisfied, the correct or actual position of the transmitter is recorded based on the use of the correct flux phases. The actual positions of the transmitter and other features such as locate points can also be displayed based on determinations described below. Operation then proceeds to 434 under an assumption that the operator is actively moving the locator laterally and the process then returns to 410 to begin anew for a new current position with new measured flux readings. Note that it is not necessary to redetermine initial parameters such as the reference yaw orientation of the transmitter. On the other hand, if the variance does not satisfy the threshold, step 440 flips the flux phase signs and operation returns to 418 such that the process repeats from that point.

At this juncture, it is worthwhile to note that each positional determination made in method 400 is essentially an independent event with respect to flux measurements. Positional determinations made for the transmitter in the Overby Patent, in contrast, are not independent events at least for the reason that Overby attempts to model the entire dipole field based on a plurality (i.e., a spaced apart series) of measurements of the field. Applicant submits that the method of Overby is significantly more computationally intensive and time consuming than method 400 of FIG. 9 at least for the reason that the entire dipole field must be recharacterized each time the inground tool is moved based on a new spaced apart series of field measurements As another concern, Overby must record a location for each flux measurement in the series which carries its own risks for implicating positional error. Method 400, in contrast, does not require determining a specific position for each flux measurement.

### Establishing Transmitter Reference Yaw Orientation

As discussed above, method 400 of FIG. 9 utilizes an initial reference yaw orientation of the transmitter at the outset of the process. A subsequent determination of the transmitter yaw orientation may be referred to as a refined reference yaw orientation. One embodiment for determining the initial reference yaw orientation or subsequent or refined reference yaw orientation of the transmitter, as described above, could utilize a magnetometer or gyroscope carried by the inground tool, however, for a magnetometer, this can be challenging or impossible when the housing of the inground tool, which carries the transmitter, includes ferromagnetic materials and can be difficult or impossible for a gyroscope due to signal drift and sensitivity to vibration. Accordingly, it is appropriate at this juncture, to disclose other embodiments for establishing the transmitter initial or refined reference yaw orientation in conjunction with cooperating features of locator 20.

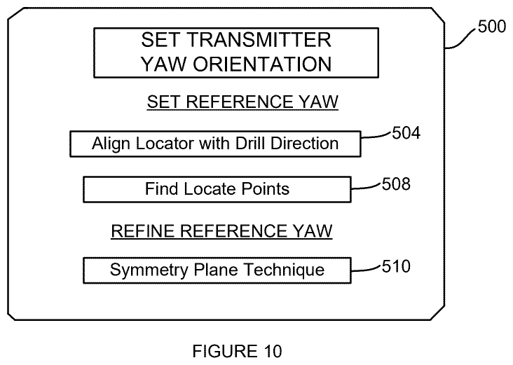

Attention is now directed to FIG. 10 which illustrates an embodiment of a menu, generally indicated by the reference number 500, on display 36 (FIG. 2) for setting the yaw orientation of the transmitter as an initial reference yaw orientation as well as for subsequently refining the reference yaw orientation. Menu 500 can be generated, for example, responsive to step 408 (FIG. 9) in order to establish an initial reference yaw orientation of the transmitter, for example, when a yaw sensor in the transmitter is not provided or is unusable. Under these circumstances, two other choices are provided for setting an initial reference yaw orientation of the transmitter. A first selection 504 by the operator subsequently initiates a first technique for establishing the initial reference yaw orientation of the transmitter. Based on selection 504, the locator instructs the operator to align the locator with an initial or intended drilling direction. It is noted that the X_{L} antenna (FIGS. 1 and 2) defines the forward direction of the locator and this antenna is at least generally aligned with the operator handle of the locator and orthogonal to the forward face of the locator housing. Hence, it is a simple and intuitive task for the operator to align the forward direction of the locator with a desired direction. Once the operator has brought the locator into such alignment, the operator can provide an indication in any suitable manner. For example, the operator can actuate trigger 48 (FIG. 2) on the locator when the locator is aligned with the intended drilling direction. In response, the locator measures the yaw orientation, for example, based on the output of yaw sensor 50 (FIG. 2). The locator then records this yaw orientation as the initial reference yaw orientation of the transmitter. This technique can generally be practiced with the transmitter above ground, for example, prior to drilling. The technique can also be applied at any suitable time during drilling to establish an initial reference yaw orientation when the operator is aware of the actual yaw orientation of the inground tool. It should be appreciated that the specification of the reference yaw orientation of the transmitter can be somewhat imprecise without adversely affecting the overall results of this overall procedure.

Another technique for determining an initial reference yaw orientation of the transmitter is entered based on operator selection of a button 508. In response to this selection, the locator can enter a locating mode that is taught by the '008 patent for finding the FLP and RLP as seen for example, in FIG. 1 of the present application as well as in FIG. 2 of the '008 patent. As seen in FIG. 1, a line extending between the FLP and RLP at the surface of the ground defines the yaw orientation of the transmitter. Once the locate points have been found, the locator can then be aligned with this line and trigger 48 can be actuated to cause the locator to record the yaw orientation of the locator as a reference yaw orientation of the transmitter, for example, based on the output of yaw sensor 50 (FIG. 2). The locate points are found based on following horizontal flux lines that define paths that lead to the locate points as seen in FIG. 2 of the '008 patent. This technique can be practiced with the transmitter in the ground.

### Subsequent Determination of Refined Reference Yaw Orientation

With continuing reference to FIG. 10 and having described two techniques for determining an initial reference yaw orientation of the transmitter, Applicants now bring to light a technique for refining or confirming yaw orientation while the transmitter is in the ground, which may be referred to as a plane of symmetry (PS) method or technique for reasons which will become evident. In other words, while the transmitter is stationary in the ground at any point during an inground operation and subsequent to initially determining a reference yaw orientation, the plane of symmetry technique can be used to conveniently determine the transmitter/inground tool yaw orientation. It is noted that a refined reference yaw determination can be made, for example, based on a desired direction of the inground tool at its current location varying by some angular amount from its actual directional heading. For instance, a refined reference yaw orientation can be determined if the actual direction is 5 degrees or more different than the desired direction. As another example, a refined reference yaw determination can be made responsive to the inground tool being offset from a desired location by a significant distance such as, for example, an offset of at least 1 foot. The plane of symmetry technique can be entered based on operator selection of a button 510. It is noted that the plane of symmetry technique can be used, for example, in order to verify that the reference yaw in use by the locator is accurate. The plane of symmetry is indicated by the reference number 132 in FIG. 1. In the plane of symmetry, Applicants recognize that the flux measured as a tangent to any flux line is parallel to the elongation axis of the dipole field such that the flux lines have a pitch in the plane of symmetry that is the negative of the pitch of the transmitter (see locating signal 120 in FIG. 1). A dashed line 514 is shown as a tangent to one of the illustrated flux lines in the figure. In an embodiment described herein, the locator can automatically guide the operator to the plane of symmetry where the negative of the measured pitch, tangent to the flux line, matches the pitch of the transmitter. Once the locator is sensing the flux in the plane of symmetry, a horizontal flux vector can be determined (essentially a projection of the tangent to a flux line in the plane of symmetry onto a surface of the ground, i.e., in the horizontal x/y plane, which is assumed to be level). The azimuthal orientation of this projection in the horizontal x/y plane matches the inverse of the yaw orientation of the transmitter. In an embodiment, once the negative of the measured pitch of the flux line matches the transmitter pitch at the plane of symmetry, the yaw orientation of the transmitter can automatically be displayed relative to the current yaw orientation of the locator. At this location, regardless of the yaw of the locator, the inverse of the yaw of the magnetic field is equal to the relative yaw of the dipole with respect to the locator. This technique is practiced with the transmitter below ground.

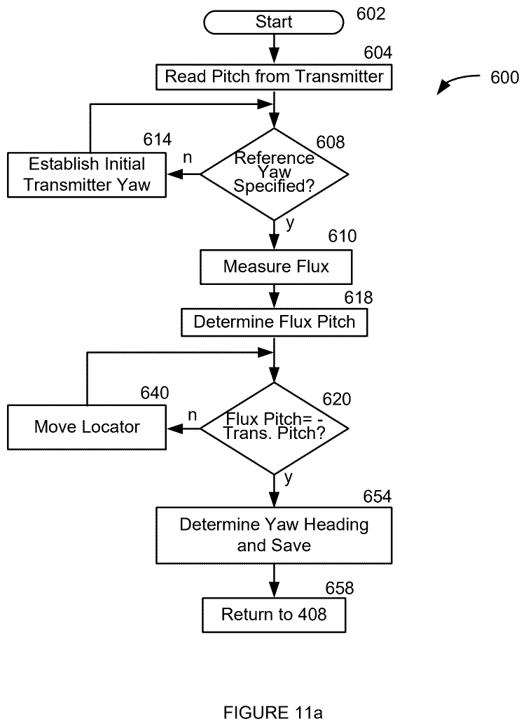

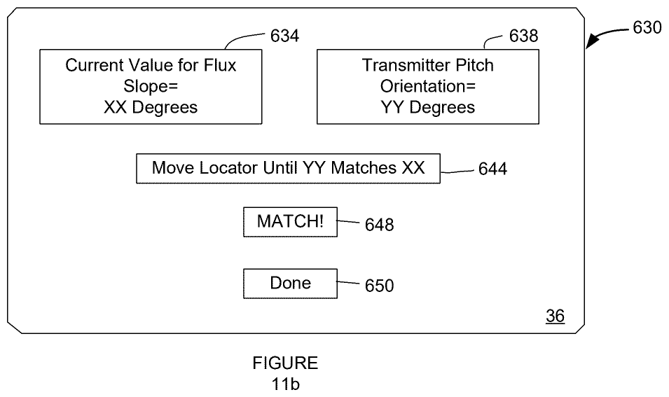

Attention is directed to FIG. 11a which is a flow diagram illustrating an embodiment of the plane of symmetry method, generally indicated by the reference number 600, that is entered responsive to selection of button 510 in FIG. 10. The method begins at 602 and proceeds to 604 which obtains the pitch of the transmitter, for example, based on demodulating the locating signal. At 608, it is determined whether a reference yaw orientation for the transmitter was previously established. If so, operation proceeds to 610. If not, operation moves to 614 for establishing an initial reference yaw orientation, for example, by presenting menu 500 to the operator for selection of one of buttons 504 or 508. Once it is confirmed by step 608 that a reference yaw orientation was established, operation at 610 measures the flux of locating signal 120 using antenna 26 (FIGS. 1 and 2). At 618, the flux orientation of the measured locating field is determined in relation to the orientation of the locator at the time of the measurement. At 620, a comparison is performed to determine whether the flux pitch determined from step 618 is equal to the negative of the transmitter pitch. As noted above, these values will be equal when the locator (i.e., antenna 26 of FIG. 2) is in or very near the plane of symmetry.

Referring to FIG. 11b in conjunction with FIG. 11a, the former is a screenshot, generally indicated by the reference number 630 for locating the plane of symmetry. The current value for the negative of the flux slope is indicated within a rectangle 634 as XX while the transmitter pitch orientation is indicated within a rectangle 638 as YY. If the two values are not equal, operation proceeds to 640 which instructs the operator at 644 in FIG. 11b to move the locator until the negative of the current slope of the measured flux, YY, matches the current transmitter pitch orientation, XX. In this way, the operator can intuitively converge on the plane of symmetry. Step 620 is looped through with continuous updates of flux slope YY. Once the flux pitch orientation matches the negative of the transmitter pitch at least within an approximation as determined, for example, based on a threshold, a match indication 648 can be provided such that the operator can then select a Done button 650. Operation can then proceed to 654 which determines the yaw heading as a projection of the measured flux onto a horizontal plane. Essentially, a vertical or B_{z} component of the measured flux can be ignored and the yaw orientation is given by:

$$Yaw = {tan}^{- 1} ( {B}_{y} , - {B}_{x} ) \qquad ( EQN . 11 )$$

where tan⁻¹ is the two-argument inverse-tangent function often written as “atan2(y,x)”, B_{y} and Bₓ are horizontal components of the measured flux and Yaw is relative to the orientation of the locator at the time of the flux measurement. The determined yaw orientation can then be recorded in master coordinates, for example, based on a reading obtained from yaw sensor 50 at the time of the flux measurement and can subsequently be used as an updated value for the yaw orientation of the transmitter for position determinations. At 658, normal operation can resume, for example, by returning to step 410 of FIG. 9.

It is noted that, at this juncture, the descriptions above provide sufficient information for generating a wide range of displays for purposes of guiding an operator based on the relative position determinations for the OHP as well as for the FLP, the RLP and the LL. A number of embodiments of suitable, but non-limiting displays will be discussed immediately hereinafter.

### Display Modes and Embodiments

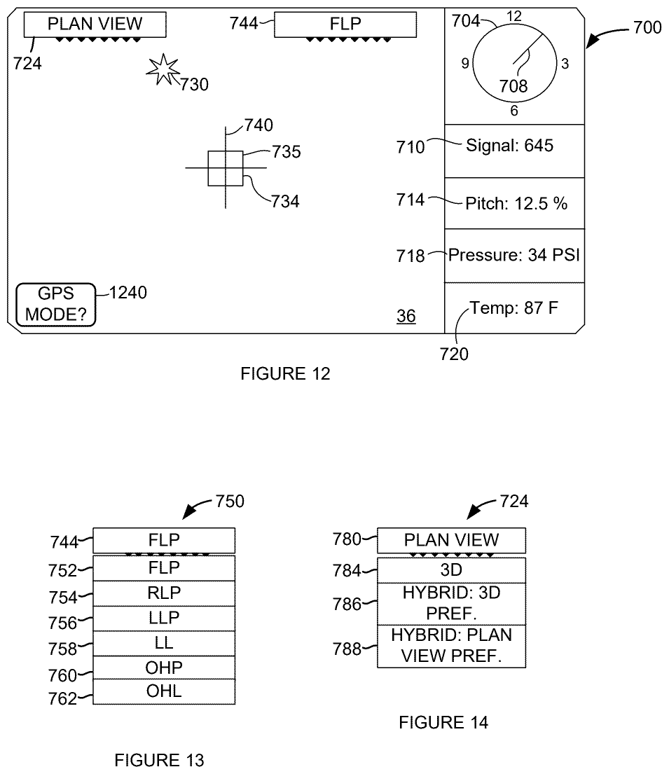

Referring to FIG. 12, an embodiment of a locating display, for presentation on display 36 or the display of any suitable device forming part of the overall drilling system such as, for example, screen 106 (FIG. 1) at the drill rig, is indicated by the reference number 700. Display 700 can present any suitable combination of information such as, for example, a clock face 704 having a hand 708 that indicates the current roll orientation of the transmitter. A signal strength 710 is show as 645. A current pitch orientation 714 of the transmitter is shown as 12.5%. An annular mud pressure 718 is shown as 34 PSI and a transmitter temperature 720 is shown as 87° Fahrenheit (30.6° C.). All of this information is available based on decoding locating signal 120 (FIG. 1). A dropdown display selection window 724 allows the operator to select from a number of different locating display modes. In the present example, a Plan View display mode has been selected. Other display modes and options available to the operator will be described below.

Display 700, in the Plan View display mode, presents a plan (i.e., overhead) view in which the display elements include the FLP, represented as a star 730, and a locator position 734, represented as a box 735 with crosshairs 740. It should be appreciated that the OHP and one or both locate points can be shown simultaneously as display elements. Given that the position and yaw orientation of the locator can be rapidly updated, display 700 can be continuously updated to show the FLP, as well as other features of interest, as the operator moves the locator. The updates can be so rapid that individual updates are imperceptible to the operator and the motion of the FLP or other point of interest is perceived as continuous. It is important to understand that the position of the locate point is not a predicted position as in the '008 patent, but rather is the actual position of the locate point relative to the current position and orientation of the locator. Thus, the operator can intuitively walk directly to the locate point on a straight line without the need to follow a curved path defined by a flux line. Applicant is not aware of any disclosure of such a capability in the prior art.

A display element selection box 744 indicates that the current display is showing the FLP. Applicant is not aware of any HDD locators in the prior art being able to automatically distinguish between the FLP and RLP without having to make a measurement at either locate point, nor of any display indicating the location of both locate points simultaneously. B_{y} selecting the display element selection box, the operator can be presented with a menu providing for modification of the current display mode, as will be described immediately hereinafter. In some embodiments of the locating display, the display element selection box is not required and the display can be generated to include all of the locating display elements that are visible in the current view, as available from among the locate points, the LL and the OHP.

Referring to FIG. 13, an embodiment of a dropdown display element selection window is illustrated, generally indicated by the reference number 750, and can be presented on display 36 responsive to operator selection of display element selection box 744 in FIG. 12. The FLP is selectable at 752 as a display element, the RLP is selectable as a display element at 754, the LLP is selectable as a display element at 756 and the LL is selectable as a display element at 758. Additionally, the OHP is selectable at 760 while the OHL is selectable at 762. The OHL will be described in further detail below. In an embodiment, the operator can select any combination of the various elements of the submenu, in which case the display element selection box 744 can indicate “CUSTOM”. In this regard, an operator can switch between different display elements or combinations of display elements at will.

FIG. 14 is a diagrammatic illustration of an embodiment of dropdown locating display selection window 724 illustrating its appearance after operator selection to allow the operator to select from and switch between a number of different locating display modes. In the present example, the plan view locating display mode has been selected as the current mode at 780. Other selectable locating display modes, yet to be described, include a 3D mode at 784, a first hybrid mode with 3D preferred at 786 and a second hybrid mode with plan view preferred at 788. Details with regard to the 3D and hybrid locating display modes will be provided immediately hereinafter.

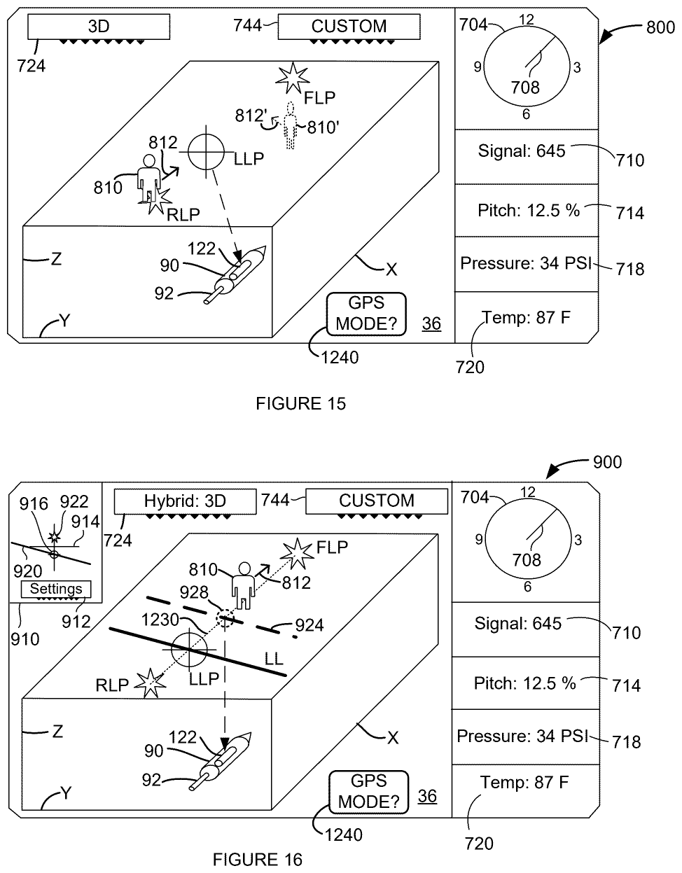

Attention is now directed to FIG. 15 which illustrates an embodiment of a 3D, custom locating display mode responsive to selection by an operator and indicated by the reference number 800. The operator can enter this view by selecting 3D button 784 in FIG. 14. The operator then selects the combination of FLP button 752, RLP button 754 and LLP 756. In the view of FIG. 15, inground tool 122 is diagrammatically shown as a boring tool supporting transmitter 122 and positioned at an inground end of drill string 92. In this example, the displayed elements are illustrated within the X, Y, Z axes of the master coordinate system with the transmitter located at the origin of the MCS. The FLP and RLP can be identified using a graphic star symbol along with an associated textual designation. It is noted that these locate points, as well as any other features in the various figures, can be illustrated in any suitable manner such as, for example, by using different colors and/or symbols for different features in conjunction with or as an alternative to the use of textual identifications. The LLP is designated by a crosshair symbol and associated textual designation. An operator is represented by an operator icon 810 and is shown at the RLP generally facing the LLP. The operator is understood to be supporting locator 20 with the locator oriented parallel to the X axis in the present illustration. The heading or yaw of the locator can be indicated by an arrow 812. As noted above, the display can update rapidly responsive to lateral movement and/or rotation of the locator. In an embodiment, operator 810 can be moved laterally and rotated in the view of the figure responsive to lateral movement and rotation of the locator. In this regard, the operator and heading arrow are shown in phantom at a different position designated by the reference numbers 810′ and 812′, respectively. By orienting the locator such that the operator icon is heading toward a feature of interest such as a locate point or the OHP, the operator can walk the locator directly to that feature. It is noted that this feature is applicable to any of the display modes that are presented by the figures. In the instance of the display mode of FIG. 12 or any other plan type view, reorienting the heading of the locator can result in FLP 730, or any other feature of interest, rotating around locator position 735. For example, if the operator orients the locator to face FLP 730, the latter will appear straight ahead on the display. In other embodiments of a 3D display mode, it should be appreciated that the operator/locator can be shown at the center of the display with features such as the locate points and the OHP rotating about the locator responsive to changing the heading of the locator. For instances in which a feature of interest is difficult to show due to scaling issues, for example, due to depth or distance, the direction to such a feature can be indicated near the edge of the display screen.

Turning to FIG. 16, an embodiment of a 3D Hybrid Preferred locating display mode is illustrated and generally indicated by the reference number 900. This locating display mode can be chosen by selecting Hybrid 3D Preferred button 786 in FIG. 14 and selecting both locate points (FLP and RLP) using buttons 752 and 754, the LLP using button 756 and the LL using button 758 in FIG. 13. It is noted that the LL is perpendicular to the yaw orientation of the transmitter at the surface of the ground at the LLP. As in FIG. 15, inground tool 90 is shown as a boring tool supporting transmitter 122 and positioned at an inground end of drill string 92 with the displayed elements illustrated within the X, Y, Z axes of the master coordinate system. Operator 810 is shown with the locator oriented toward the FLP, as indicated by arrow 812.

The 3D Hybrid Preferred locating display mode further includes an inset view 910 that is a plan view that can be based on the plan view locating display mode of FIG. 14. The operator can customize the elements shown in the inset view by selecting a Settings button 912 that presents the operator with display element selection box 744 of FIG. 13. In the present example, a locator (assumed to be held by an operator) is centered on crosshairs 914. LLP916 and LL 920 are also shown along with FLP 922.

Still referring to FIG. 16 and in an embodiment, the OHL can be shown either in place of or in addition to the LL. The OHL 924 is shown in phantom as a dashed line which passes through the OHP 928 (also shown in phantom as a dashed circle) directly above the transmitter. The OHL is shown as parallel to the LL but, like the OHP, is laterally displaced from the LL when the transmitter is pitched. Since the transmitter is pitched up at 12.5 percent, the LL is behind the OHL with respect to the drilling direction. Applicant recognizes that the OHP is characterized, detectable and displayable based on a flux pitch, given as:

$${OHP}_{pitch} = - a tan [ 2 * tan ( {θ}_{T} ) ] \qquad ( EQN . 12 )$$

where θ_{T} is the pitch of the transmitter.

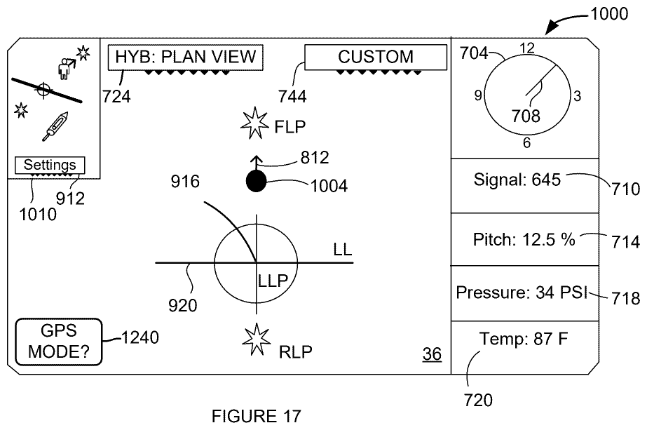

In FIG. 17, an embodiment of a Hybrid Plan View Preferred locating display mode is illustrated and generally indicated by the reference number 1000. This display mode can be chosen by selecting Hybrid Plan View Preferred button 788 in FIG. 14 and selecting LL button 758 and LLP button 756 such that the LLP and the LL are presented on the display. A locator 1004 is represented as a solid circle, locate line point 916 is shown, and LL 920 is shown as a line passing through LLP 916. An inset view 1010 is a miniaturized version of the 3D main view presented in FIG. 16 showing the LLP and the LL, as well as the FLP and the RLP.

Having described a range of different 3D locating embodiments above, it is submitted that these embodiments provide benefits that have not been seen heretofore including the ability to determine and display the actual locations of locate points at a distance therefrom as well as the ability to selectably display a wide range of different combinations of dipole locating field elements display elements that can be of interest to an operator.

### GPS Enabled Embodiments

Attention is now directed to an embodiment of locator 20 including a precision GPS unit 60 providing a GPS locating mode that is stable at or near plane of symmetry 132 (FIG. 1), although the GPS locating mode can be used at any time or exclusively based on operator selection. The described GPS locating embodiments further resolve concerns relating to a low gradient of dipole signal strength along the OHL and the LL as well as at the OHP and the LLP in a way that is submitted to provide heretofore unseen benefits over the prior art. The result is an enhanced accuracy along the OHL and the LL as well as at the OHP and the LLP that has not previously been seen in the prior art. In an embodiment described immediately hereinafter, the locator can automatically switch to GPS locating mode based on proximity to the plane of symmetry.

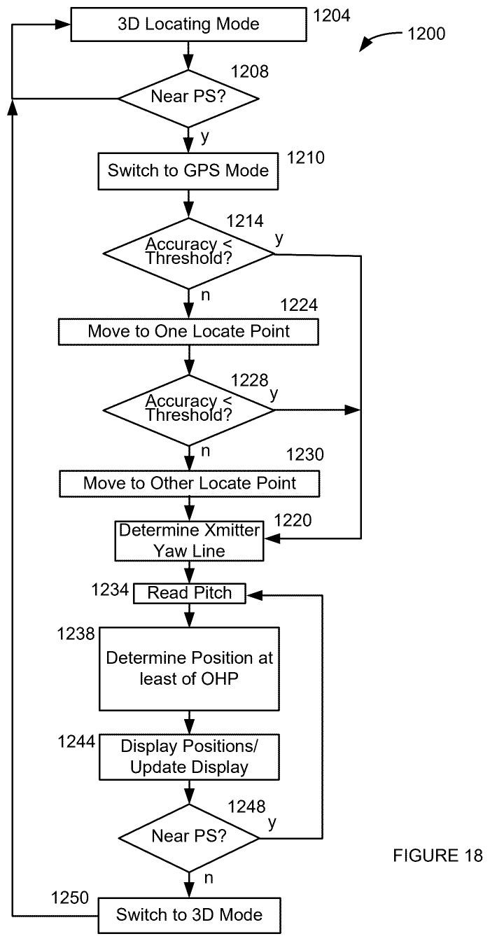

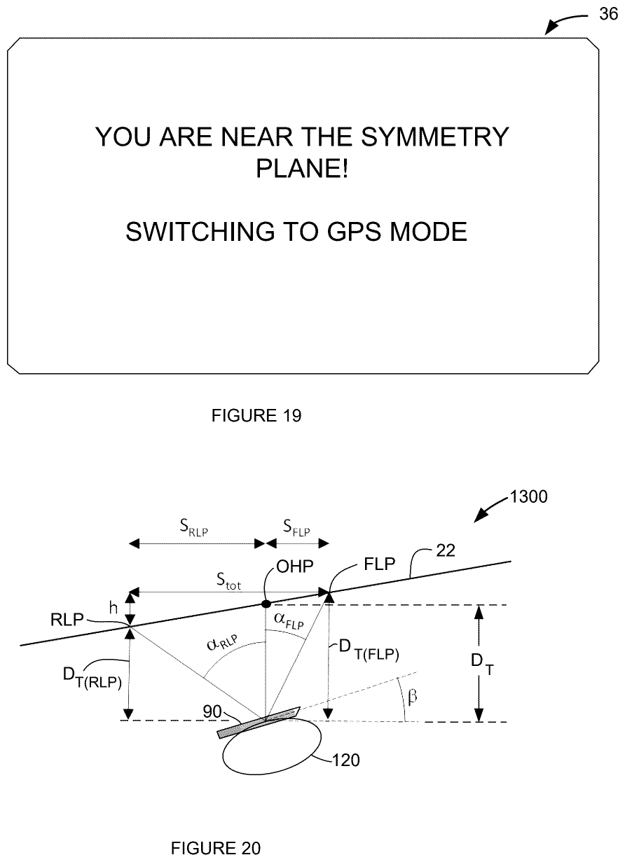

FIG. 18 is a flow diagram illustrating the operation of an embodiment of locator 20 with a GPS mode, generally indicated by the reference number 1200. The method begins at 1204 with the walkover locator initially operating in a 3D locating mode to generate any of the displays, for example, shown in FIGS. 12 and 15-17, based on method 400 of FIG. 9. At 1208, the locator determines whether it is near plane of symmetry 132, by way of non-limiting example, by comparing the current pitch of the transmitter to the local slope of the flux lines at the current location of the locator (see step 620 of method 600, shown in FIG. 11a). If it is determined that the locator is not at or near the plane of symmetry, operation returns to 1204, remaining in the 3D locating mode. On the other hand, if the locator is determined to be at or near the plane of symmetry (for example, at least within some threshold value of the current transmitter pitch), the method proceeds to 1210 for purposes of switching to a GPS locating mode. The threshold value can be any suitable value such as, for example, from 2 degrees to 20 degrees. With reference to FIG. 19 and in one embodiment, screen 36 can provide a notification that operation is switching to GPS mode due to proximity of the plane of symmetry.

Continuing with the description of FIG. 18, at 1214, the accuracy of one or more points of interest, such as the depth, RLP, FLP, OHP and LLP, is established and compared to one or more threshold values. For example, the accuracy of positions of the locate points (FLP and RLP), determined in either in the MCS or the GPS coordinate system can be tested, based on location data recorded up to the present time, for instance, in the 3D Locating Mode. In an embodiment, accuracy can be evaluated based on variance of the determined locate point positions over some time period, for example 1-10 seconds. In this regard, Applicant projects that locator 20 will be capable of making at least 25 position determinations per second for the locate points in the 3D Locating Mode. In the GPS mode, it is projected that up to 100 position determinations can be made per second. As an accuracy threshold, the variance for each of the locate points can be 10 cm. Thus, accuracy values that are 10 cm or less can satisfy the threshold. Of course, such a variance test can be applied to any suitable position such as, the OHP and the LLP. If the variance is less than the threshold, the accuracy test is satisfied and operation can proceed to step 1220, yet to be described. In another embodiment, the accuracy test at 1214 can be based on a plurality of position determinations for any desired spatial location such as, for example, an area near either locate point or between a locate point and the plane of symmetry by holding the locator stationary to gather a plurality of position determinations at the desired location. In still another embodiment, the variance can be weighted based on the magnitude of the signal strength of the locating signal corresponding to a particular location at the time the position data was collected. For example, if signal strength is high, the variance determined for a particular position can be reduced. In addition to a variance in determined positions (coordinates) of locate points or other points of interest, variations of other parameters can be used to determine accuracy including but not limited to a raw (i.e., unprocessed) signal strength in one or more locating antenna axes at a given location, the determined position of transmitter 122 and derived parameters such as a transmitter yaw line extending between the RLP and RLP.

Returning to the discussion of step 1214, if the accuracy determination does not satisfy the particular threshold that is being applied, operation proceeds to step 1224 which instructs the operator to move towards one of the locate points based, for example, on a current GPS position of the locator relative to a last-determined position for one of the locate points, which can be the nearest locate point. Any suitable display format can be used such as, for example, a plan view of the locator GPS position relative to the locate point position wherein the operator simply converges the GPS position of the locator onto the displayed position of the locate point. Since the last-determined position of the locate point may have been made in the MCS coordinate system subject to some inaccuracy, for example, due to interference, the locator can refine a new position determination of the locate point based on instructing the operator to move the locator until the measured flux is vertically oriented. At that point, a new/refined GPS position of the locate point can be recorded. Having a new, more accurate GPS position for one locate point, a corrected position for the other locate point can be determined, as will be described immediately hereinafter.

At the FLP, the distance R between the locator and the transmitter is given by:

$$R = {\{ {B}_{z} [ - sin ( θ ) + \sqrt{{8 [ cos ( θ ) ]}^{2} + {9 [ sin ( θ ) ]}^{2}} ] / 4 \}}^{- 1 / 3} \qquad ( EQN . 13 )$$

where θ is the pitch of the sonde and B_{z} is the measured magnetic field at the FLP, which is only in the Z (i.e., vertical) direction. At the RLP, distance R is given by EQN. 13 with B_{z} replaced by −B_{z} and θ replaced by −θ. An angle, α, is an FLP angle measured as an angle from a vertical line extending through the transmitter and the OHP, to a direction pointing to a current position of the locator and is given as:

$$α = {tan}^{- 1} [ \frac{{B}_{z} * cos ( θ )}{( 1 / {R}^{3} ) + {B}_{z} * sin ( θ )} ] \qquad ( EQN . 14 )$$

The depth of the transmitter, D, is:

$$D = R * sin ( α + θ ) \qquad ( EQN . 15 )$$

From EQN. 8 and EQN. 9 above, a distance between the two locate points, SFLP-RLP, is:

$${S}_{FLP - RLP} = 2 * D * \sqrt{{8 [ cos ( θ ) ]}^{2} + {9 [ sin ( θ ) ]}^{2}} / [ 4 cos ( θ ) ] \qquad ( EQN . 16 )$$

The position of the FLP in the GPS coordinate system is then the position of the RLP plus the distance SFLP-RLP, in the direction of the reference yaw. Conversely, the position of the RLP is in the opposite direction of the reference yaw (i.e., minus the distance SFLP-RLP) if R is determined for the FLP using EQN. 13.

Subsequent to step 1224, operation can then proceed to step 1228 which can repeat the same process as applied by previously described step 1214 to compare the variance among a plurality of position determinations for the locate points to the threshold based on the new/refined GPS position for one locate point and the corrected GPS position for the other locate point. If the threshold is satisfied, operation can proceed to 1220.

On the other hand, if the threshold is not satisfied at 1228, operation can proceed to 1230 which instructs the operator to move the locator to the other locate point. At the other locate point, a refined GPS position can be determined in the same manner as described above for the first locate point. It is noted that, having moved the locator to both locate points and recording associated GPS positions, the highest obtainable level of accuracy has been reached.

Operation transfers to step 1220 via any one of steps 1214, 1228 or 1230 based on sufficiently accurate GPS locate point positions having been established. Step 1220 determines a transmitter yaw line extending between the GPS coordinates of the two locate points (RLP and FLP) such that any given GPS position of the locator can be characterized relative to the transmitter yaw line and locate points. Note that FIG. 16 illustrates the transmitter yaw line as a dotted line indicated by the reference number 1230. Both OHP 928 and the LLP are seen on the transmitter yaw line.

Still referring to FIG. 18 and subsequent to step 1220, the pitch orientation of the transmitter is read at 1234. Based on the GPS locations of the FLP and the RLP in conjunction with the measured pitch, positions of interest are determined at least including the OHP by step 1238. With a flux measurement available taken at the FLP, the location of the OHP can be determined initially based on a radial distance r from the transmitter to the locator, given as:

$$r = 0.2 {5}^{- 1 / 3} {\{ - {B}_{FLP} * sin ( θ ) + \sqrt{9 * {[ {B}_{FLP} * sin ( θ ) ]}^{2} + 8 * {[ {B}_{FLP} * cos ( θ ) ]}^{2}} \}}^{- 1 / 3} \qquad ( EQN . 17 )$$

where B_{FLP} is the flux value at the FLP, θ is the pitch orientation of the transmitter and α is a (front) locate point angle measured as an angle from a vertical line extending through the transmitter and the OHP, to a direction pointing at the current location of the locator, given as:

$$α = {tan}^{- 1} [ \frac{{B}_{FLP} * cos ( θ )}{{r}^{- 3} + {B}_{FLP} * sin ( θ )} ] \qquad ( EQN . 18 )$$

A horizontal distance S_{FLP} from the FLP toward the OHP along the transmitter yaw line can be determined based on the expression:

$${S}_{FLP} = r * cos ( α + θ ) \qquad ( EQN . 19 )$$

And a vertical distance D_{T(FLP)} or depth of the transmitter below the OHP, as determined from FLP values, can be based on the expression:

$${D}_{T ( FLP )} = r * sin ( α + θ ) \qquad ( EQN . 20 )$$

Using S_{FLP} as an offset from the GPS coordinates of the FLP along the transmitter yaw line, coordinates for the OHP can be determined. Using D_{T(FLP)} as the depth of the transmitter below the OHP, coordinates for the transmitter itself can then be determined.

Equations 17-20 can be modified to determine the coordinates of the OHP and the transmitter relative to the RLP, as follows:

$$r = \text{} 0.2 {5}^{- 1 / 3} * {\{ - {B}_{R L P} * sin ( - θ ) + \sqrt{\begin{matrix}9 * {[ {B}_{R L P} * sin ( - θ ) ]}^{2} + \\ 8 * {[ {B}_{R L P} * cos ( - θ ) ]}^{2}\end{matrix}} \}}^{- 1 / 3} \qquad ( EQN . 21 )$$

where r is the radial distance of the RLP from the transmitter and B_{RLP} is the locating signal strength at the RLP. The angle α, in association with the RLP, is given as:

$$α = {tan}^{- 1} [ \frac{{B}_{RLP} * cos ( - θ )}{{r}^{- 3} + {B}_{RLP} * sin ( - θ )} ] \qquad ( EQN . 22 )$$

The horizontal distance S_{RLP} from the RLP toward the OHP along the transmitter yaw line can be determined based on the expression:

$${S}_{RLP} = r * cos ( α - θ ) \qquad ( EQN . 23 )$$

And the vertical distance D_{T(RLP)} or depth of the transmitter below the OHP, as determined from RLP values, can be based on the expression:

$${D}_{T ( RLP )} = r * sin ( α - θ ) \qquad ( EQN . 24 )$$

It is noted that dual positional determinations of the OHP and the transmitter position can be made for both the FLP and the RLP in the instance of flux measurements being available for both the RLP and the FLP. The final position coordinates for the OHP can be an average value which is likewise the case with the depth of the transmitter. As a confirmation of accuracy, distance between the FLP and the RLP can be determined as Dₜₒₜ and compared to a GPS distance between the FLP and RLP such that:

$${S}_{tot} = {S}_{FLP} + {S}_{RLP} \qquad ( EQN . 25 )$$

If the GPS mode is entered at 1210, for example, from the 3D locating mode with no flux readings taken at either locate point, one embodiment can route operation from step 1214 to step 1224 to obtain flux measurements for one locate point and operation can then route to 1228. In another embodiment, when locate point positions have previously been determined with sufficient accuracy, for example, based on variance, yet no flux measurements were taken at either locate point, operation can route from step 1214 to step 1220 for determining the transmitter yaw line. Lateral or left/right guidance can be provided based on GPS offset from the transmitter yaw line while pitch readings taken at 1234 can serve as an input to EQN. 12. In this regard, the locator has arrived at the OHP when the pitch of the flux, determined by EQN. 12 matches the current pitch of the transmitter. In still another embodiment, again with sufficient locate point position accuracy but no flux measurements at the locate points, the position of the OHP can be determined in a manner that will be described at an appropriate point hereinafter.

It is noted that the GPS mode just described, as well as embodiments described below, are not limited to use at or near the plane of symmetry, but can be switched to at any time by the system automatically for other reasons that may be identified in the future, manually by the operator, or GPS Mode can be used exclusively. Manual switching can be accomplished, for example, by selecting a “GPS Mode?” button 1240 which appears in FIGS. 12 and 15-17. While in the GPS mode, button 1240 can say “3D Mode” to allow the operator to revert back to the 3D mode.

Having determined the position of at least the OHP, method 1200 can continue at 1244 by generating (or updating) display 36 to show the OHP and the transmitter which can be in conjunction with one or both of the FLP and the RLP. Given that the coordinates for the OHP and the transmitter are known, the display can be generated based on the current GPS position of the locator. A two dimensional display can appear similar to the display of FIG. 17 while a three-dimensional display can appear similar to the display of FIG. 16, each of which displays includes features of interest that can be designated by the operator in a manner that reflects the descriptions above. It is noted that the display can be updated as rapidly as new, updated GPS positions are generated by the system. At 1248, proximity to the plane of symmetry is tested for. If the locator is still near the plane of symmetry, operation returns to 1234 which reads a new pitch value. On the other hand, if the locator is no longer near the plane of symmetry, switching back to the 3D mode can be initiated at 1250 which then returns operation to step 1204. Of course, the locator can remain in the GPS mode if the operator has specified exclusive use of the GPS mode.

The GPS mode described above can be modified, in another embodiment, to account for an elevation difference between the RLP and the FLP under the circumstance that the surface of the ground is not level. Attention is directed to FIG. 20 which is a diagrammatic illustration, in elevation, of the variables of interest, generally indicated by the reference number 1300 and most of which should be apparent to the reader based on the descriptions above. It is noted that h represents a difference in elevation between the RLP and the FLP at surface 22 of the ground. Angles α_{FLP} and α_{RLP} are representative of the variable α seen in Equations 18 and 22, but are in consideration of a non-level ground surface at the FLP and the RLP, respectively.

Referring to FIG. 18 in conjunction with FIG. 20, step 1220, in this embodiment, can utilize a recorded GPS elevation value in conjunction with latitude and longitude for each locate point. If no elevation values are available, operation can proceed by assuming level terrain, as will be seen. The difference for the illustrated slope in FIG. 20 is a positive value for h, while an opposing slope would yield a negative value for h. The value for Sₜₒₜ can be determined based on the measured GPS coordinates in three dimensions for the total linear distance between the FLP and the RLP. Angle α_{FLP} of the transmitter can be determined by the expression:

$${α}_{FLP} = {tan}^{- 1} ( \frac{- \{ 3 * sin ( θ ) - \sqrt{9 * {[ sin ( θ ) ]}^{2} + 8 * {[ cos ( θ ) ]}^{2}} \}}{4 * cos ( θ )} ) \qquad ( EQN . 26 )$$

Angle α_{RLP} of the transmitter can be determined by the expression:

$${α}_{RLP} = {tan}^{- 1} ( \frac{\{ 3 * sin ( θ ) + \sqrt{9 * {[ sin ( θ ) ]}^{2} + 8 * {[ cos ( θ ) ]}^{2}} \}}{4 * cos ( θ )} ) \qquad ( EQN . 27 )$$

The depth of the transmitter, essentially as a projection onto a vertical line extending through the OHP and the transmitter from the RLP, can be determined based on the expression:

$${D}_{T ( RLP )} = \frac{{S}_{tot} - h * tan ( {α}_{FLP} )}{tan ( {α}_{FLP} ) + tan ( {α}_{RLP} )} \qquad ( EQN . 28 )$$

Distance S_{RLP} can be determined based on:

$${S}_{RLP} = {D}_{T ( RLP )} * tan ( {α}_{RLP} ) \qquad ( EQN . 29 )$$

And, depth of the transmitter D_{T(FLP)} can be determined, again essentially as a projection onto a vertical line extending through the OHP and the transmitter from the FLP, based on:

$${D}_{T ( FLP )} = {D}_{T ( RLP )} + h \qquad ( EQN . 30 )$$

Distance S_{FLP} can be determined as:

$${S}_{FLP} = {D}_{T ( FLP )} * tan ( {α}_{FLP} ) \qquad ( EQN . 31 )$$

On level ground, it is noted that h=0 such that D_{T(FLP)} is equal to D_{T(RLP)} and both values are equal to Dr. It is therefore noted that EQNs. 26-31 are applicable for determining the position of the OHP at step 1238 of FIG. 18 when there is sufficient locate point position accuracy (determined at 1214), but locate point flux measurements are not available.

On sloped ground, Dr can be determined by first determining the slope of the ground and assuming a constant slope from the RLP to the FLP with the slope given as:

$$slope = {tan}^{- 1} ( \frac{h}{{s}_{tot}} ) \qquad ( EQN . 32 )$$

A value for h at the OHP is given as:

$${h}_{OH ( RLP )} = {S}_{RLP} tan ( slope ) \qquad ( EQN . 33 )$$

And the overhead depth is given as:

$${D}_{T} = {D}_{T ( RLP )} + {h}_{OH ( RLP )} \qquad ( EQN . 34 )$$

If it is desired to determine the position of the LL, an offset distance can be added to S_{FLP} or subtracted from S_{RLP} to give the position along the transmitter yaw line. That offset distance is given by:

$$offset = \frac{- {D}_{T} * \{ 3 * cos ( θ ) - \sqrt{8 * {[ sin ( θ ) ]}^{2} + 9 * {[ cos ( θ ) ]}^{2}} \}}{2 * sin ( θ )} \qquad EQN . 35$$

It is noted that the GPS mode beginning with step 1210 of FIG. 18 facilitates the display of the position of at least the OHP with no requirement for the operator to actually walk to the OHP even though the operator may do so based on continuing updates by step 1244 as the operator moves the locator near the plane of symmetry.

Attention is now directed to another embodiment for operating locator 20 in a GPS mode using precision GPS unit 60 to provide another GPS locating mode that is stable at or near plane of symmetry 132 (FIG. 1), although this GPS locating mode, as is the case with the GPS mode described with regard to FIG. 18, can be used at any time or exclusively based on operator selection.

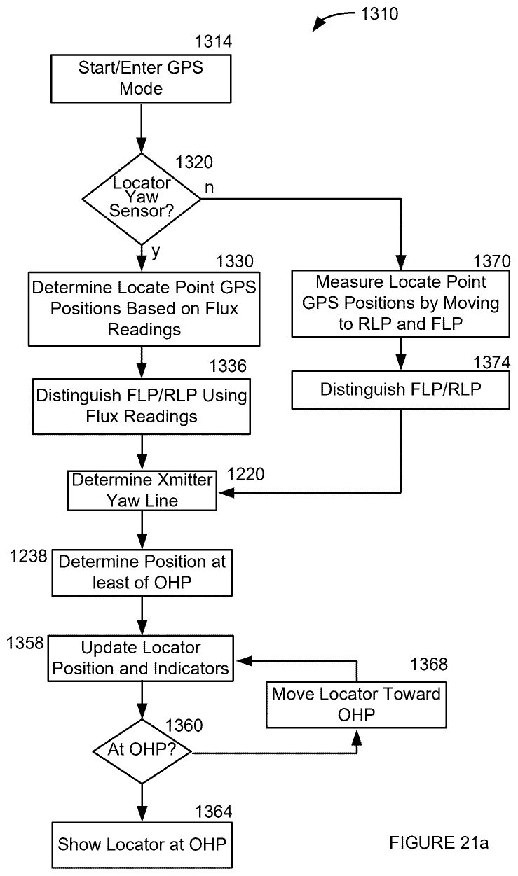

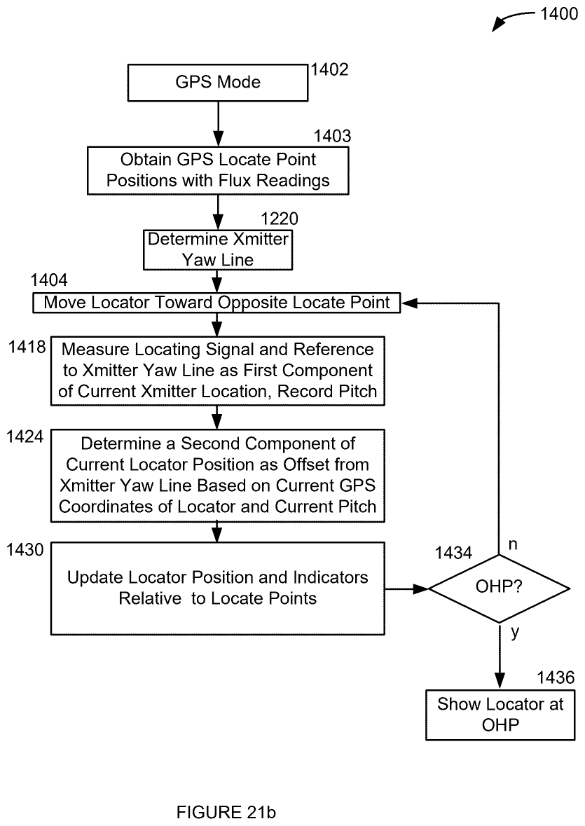

FIG. 21a is a flow diagram illustrating the operation of another precision GPS embodiment, generally indicated by the reference number 1310. Method 1310 can be a standalone GPS mode or can be integrated into an overall method such as method 1200 of FIG. 18 at 1210. It is noted that method 1310 includes certain steps previously described with regard to method 1200. Accordingly, descriptions of these steps may not be repeated for purposes of brevity and the reader is referred to the descriptions above. Method 1310 can start or enter the GPS mode at 1314 with the GPS positions of the locate points and flux readings at the locate points being unknown. The procedure then depends on whether the locator has a yaw sensor at 1320. If a yaw sensor is present, operation proceeds to 1330 at which the positions of the Locate Points are determined using flux readings, for example, using Equations 1-10, then those locate point coordinates in the MCS are transformed to GPS coordinates. Note that steps 1214 through 1230 in FIG. 18 may be carried out if necessary to improve the accuracy of the locate point positions. Operation continues to 1336, identifying one set of coordinates as the FLP and another as the RLP. Next, at 1220, the transmitter yaw line is determined using the fact that it passes through the FLP and RLP. At 1238, the position of the OHP can be established using Equations 26-34, and, if desired, the LLP using Equation 35. Once the OHP, or LLP, has been determined in GPS coordinates, the locator can indicate which direction to travel to arrive at the OHP/LLP based on the established position of the OHP/LLP and the current GPS position of the locator. Locator position and indicators are updated at 1358. After arriving at the OHP as determined by step 1360, or sufficiently close, within an acceptable limit, the method finishes at 1364. On the other hand, if step 1360 determines that the locator is not at the OHP, operation proceeds to 1368 which instructs the operator to move the locator, for example, using directional indications, for example, as yet to be described. These indications serve to converge the current GPS position of the locator onto the established position of the OHP. Returning back to 1320, if the locator does not have a yaw sensor, at 1370 the locator is moved to each locate point and the GPS positions are recorded. At 1374, the locate points are distinguished as to which is the RLP and which is the FLP. This can be accomplished, for example, by examining the history of previous GPS positions of the sonde and associated points of interest (OHP, LLP, RLP, FLP, etc.) Since drilling to form a pilot bore is generally unidirectional, the locate point that is farthest from a prior transmitter position such as, for example, a prior transmitter position or a prior FLP position, the FLP can be identified based on being further from the prior position than the RLP. Operation then proceeds to 1220 and proceeds therefrom as described above.

Attention is now directed to FIG. 21b which is a flow diagram illustrating the operation of another precision GPS embodiment, generally indicated by the reference number 1400. It is noted that method 1400 includes steps previously described with regard to method 1200 of FIG. 18 as well as method 1300 of FIG. 21a. Accordingly, descriptions of these steps may not be repeated for purposes of brevity and the reader is referred to the descriptions above. Method 1400 enters the GPS mode at 1402. At 1403, GPS locate point positions with flux readings are obtained, for example, using one of step 1330 or step 1370 of FIG. 21a, as described above. At 1220, the locator determines the transmitter yaw line. At 1404, the locator is moved from the nearest locate point toward the opposite locate point along the transmitter yaw line based on the current GPS position of the locator.

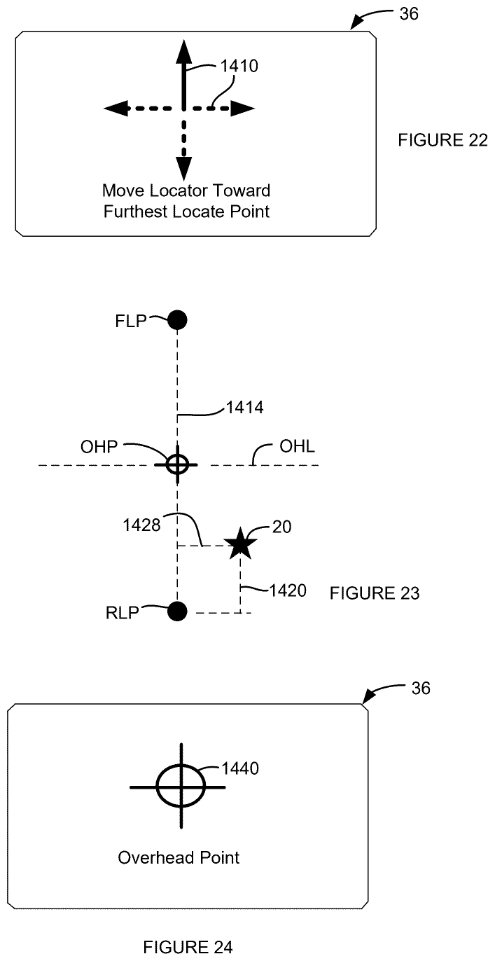

Referring to FIG. 22 in conjunction with FIG. 21b, the former is a screen shot illustrating the appearance of one embodiment of display 36 to provide directional guidance, for example, to the OHP responsive to movement of the walkover locator. Directional indications 1410 can indicate a desired direction of movement to the operator, for example, based on GPS coordinates of the current location of the locator and the locations of the locate points in relation thereto. In the present embodiment, indications are fore/aft and left right arrows with the current indication shown as a solid line, although any suitable form of display indication can be used including a single arrow that points directly at the opposite/furthest locate point responsive to movement of the walkover locator. It is noted that step 1404 of FIG. 21b can initiate the screen of FIG. 22 to prompt the operator to move the walkover locator toward the furthest locate point. It is noted that the directional indications of FIG. 22 can be employed any time there is a need for the operator to move the locator to a locate point such as, for example, relating to steps 1224 and 1230 of FIG. 18.

Turning to FIG. 23 in conjunction with FIG. 21b and 22, the former is a diagrammatic plan view illustrating walkover locator 20 as a star at a current GPS location along with the FLP the RLP GPS positions such that the walkover locator is at least initially nearest to the RLP by way of non-limiting example. It should be appreciated that FIG. 23 can represent one suitable embodiment of a screen shot out of many possibilities that are within the scope of the present disclosure. The transmitter yaw line is indicated by the reference number 1414. At 1418 and as the walkover locator is moved, the locating signal is measured to characterize values such as signal strength and field orientation or slope that can be recorded with reference to GPS position along or projected onto the transmitter yaw line as a first component 1420 of the walkover locator position. At 1424, a second component 1428 of the current position of the walkover locator is determined as a lateral or left/right offset from transmitter yaw line 1414 based on GPS coordinates of the walkover locator relative to transmitter yaw line 1414 and independent of the locating signal. As will be seen, this is most significant near the plane of symmetry of the locating signal (item 132, FIG. 1) which is coincident with the OHP and the LL when the transmitter is level.

At step 1430 of FIG. 21b, the walkover locator position is updated as well as indicators 1410 of FIG. 22. Operation proceeds at 1434 by comparing the flux pitch or orientation of the locating signal at the current position of the walkover locator to the pitch orientation of the transmitter. Applicant recognizes that when the measured flux pitch orientation is equal to the negative of the pitch orientation of the transmitter, or at least within some threshold value from the pitch orientation, the walkover locator is in plane of symmetry 132 which contains the OHL, shown in FIG. 23. Once the locator is on the OHL, only left/right indications 1410 are needed to direct the operator to the OHP. As noted above, the left/right indications are based on GPS proximity to transmitter yaw line 1414. When the walkover locator is detected to be at the OHP, operation moves to 1436 and an OHP indication 1440 can be provided, for example, as shown in the screenshot of FIG. 24. It should be appreciated that method 1400 can direct the operator to the LL or LLP by detecting a level/horizontal flux orientation at step 1434, accompanied by appropriate adjustments in the display.

Based on the foregoing, the operator is provided with the flexibility to switch at will between a highly accurate GPS enabled embodiment, which is stable at all times, or highly advanced isometric displays when sufficiently offset from the plane of symmetry. Further, an operator can take advantage of automatic switching, for example, between a 3D isometric mode and a precision GPS enabled mode or other suitable mode to essentially remove constraints that would otherwise arise based on instability proximate to or in the plane of symmetry. In this way, the operator is not faced with manual monitoring of proximity to the plane of symmetry which might result in reduced accuracy positional determinations or the absence of positional determinations.

### GPS Antenna Offset

Referring to FIG. 1 with regard to offset 62, it should be appreciated that offset 62 can lead to a significant positional uncertainty in the location of triaxial antenna 26. This uncertainty can be at least as large as the horizontal component and/or vertical component of the offset. In one example as much as 14 cm of horizontal positional error and 20 cm of vertical positional error can be introduced. Additional horizontal and vertical offset can be introduced when the locator is tilted. Accordingly, compensation for this offset will be described immediately hereinafter.

Referring to FIG. 2, GPS receiver 60 will output the accurate position of the GPS antenna. Geometrically, however, the locator is free to swing around the GPS antenna, tracing out a circle of possible positions in a horizontal plane. In fact, this motion is not restricted to horizontal motion. Because the locator can pitch up and down and roll side to side, a spherical shell is defined that represents every possible triaxial antenna position for a given GPS antenna position. Practically speaking, the locator will be held close to level, so the circle visualization is closer to reality. If it is assumed that the position of the GPS antenna represents the position of the triaxial locating signal antenna, there will be significant error in the position of the triaxial antenna and thus the calculated position of the transmitter. Given that a precision GPS can determine the position of its antenna that can be accurate to within +1 cm, offset error introduced by spaced apart GPS and locating signal antennas, that is greater than the native capability of the precision GPS system itself, is unacceptable to Applicant.

In the embodiment of FIG. 2, offset 62 is predetermined and essentially unchanging with respect to the frame or chassis of the locator. That is, the relative positional relationship between the antennas is unchanging in the reference coordinate axes system X_{L}, Y_{L}, Z_{L} of the locator (see FIGS. 1 and 2) with an origin that can be, for example, at the center of triaxial antenna 26. In order compensate for this offset, however, it is necessary to determine the orientation of the locator in a coordinate system that is referenced to the earth itself, which can be referred to as earth-based coordinates. GPS coordinates are earth-based and are commonly specified for the surface of the earth based on the combination of latitude and longitude, where longitude is measured from the prime meridian passing through Greenwich, UK and latitude measured north/south from the equator. Of course, GPS coordinates can also specify an elevation. For subsequent reference, another useful coordinate system, that is earth-based, is the ECEF (Earth-Centered Earth Fixed) coordinate system which is a Cartesian spatial reference system that represents locations in the vicinity of the Earth with the origin at the center of mass of the earth, the Z axis extending between the North and South poles with positive values increasing to the North, the X axis in the plane of the equator passing through the origin and extending from 180° longitude to the prime meridian, and the Y axis also in the plane of the equator but extending from 90° West longitude to 90° East Longitude.

From GPS measurements and orientation measurements, the orientation of the locator can be determined, for example, in GPS coordinates. In one embodiment, with the locator being held at least approximately level by the operator, the position of the triaxial antenna can be determined in GPS coordinates based on the GPS coordinates of the GPS antenna in conjunction with the output of yaw sensor 50. In another embodiment, a bubble level or other such device can be mounted on the walkover locator to assist the operator in holding the walkover locator level. In still another embodiment, the position of the triaxial antenna can be determined in GPS coordinates based on the GPS coordinates of the GPS antenna in conjunction with the output of yaw sensor 50 and the output of tilt sensor 50 such that it is not necessary for the operator to hold the walkover locator in a level orientation. Knowing the measured electromagnetic flux, associated values can be projected onto the axes of a coordinate system that is rotated to level at the origin of the locator referenced to a level locator reference axes coordinate system.

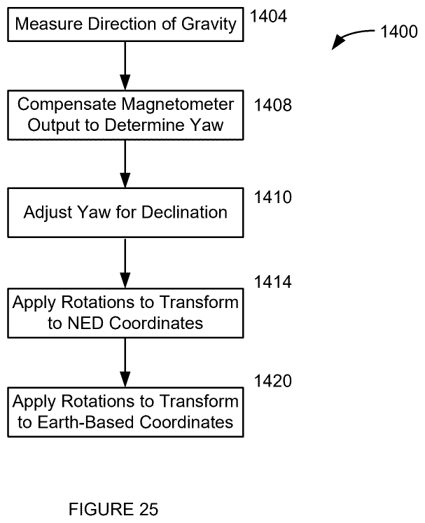

FIG. 25 is a flow diagram that illustrates one embodiment of a method for determining the position of triaxial antenna 26 in earth-based coordinates, generally indicated by the reference number 1400. Method 1400 considers an embodiment of locator 20 including a triaxial magnetometer as yaw sensor 50 and a triaxial accelerometer as tilt sensor 34. At 1404, the direction of gravity is established based on the output of the accelerometer in order to determine the roll and pitch of the locator in its current orientation. When resting, for example, on a flat surface, the locator experiences an acceleration that opposes gravity to keep the device stationary. As such, the measured acceleration is in the opposite direction of gravity or −g. Accounting for this, it can be said that the accelerometer measures gravity, which is referred to as g. In the present example, it is assumed that the measurement axes of the triaxial accelerometer are aligned with the fixed X_{L}, Y_{L} and Z axes (FIG. 1) of the locator to provide outputs gₓ, g_{y} and g_{z}. The angle between the Z_{L} axis of the locator and gravity determines the angles of pitch and roll. The roll can be determined as:

$$Roll = ψ = {tan}^{- 1} ( \frac{{g}_{y}}{{g}_{z}} ) \qquad ( EQN . 36 )$$

The pitch can be determined as:

$$Pitch = ϕ = {tan}^{- 1} ( \frac{- {g}_{x}}{{g}_{y} sin ψ + {g}_{z} cos ψ} ) \qquad ( EQN . 37 )$$

At step 1408, the roll and pitch are used to compensate the magnetometer output for tilt and find the compass heading or yaw β of the locator. This involves applying a negative rotation for both the roll and pitch angles, and is equivalent to measuring the magnetic field if the magnetometer were held perfectly level. As is the case with the triaxial accelerometer, it is assumed that the measurement axes of the triaxial magnetometer are aligned with the fixed X_{L}, Y_{L} and Z_{L} axes (FIG. 1) of the locator to provide outputs Bₓ, B_{y} and B_{z}. This operation can be simplified to the following equation for yaw:

$${Yaw}_{{m}_{}} = {β}_{m} = {tan}^{- 1} ( \frac{{B}_{z} sin ψ - {B}_{y} cos ψ}{{B}_{x} cos ϕ + {B}_{y} sin ϕ sin ψ + {B}_{Z} sin ϕ cos ψ} ) \qquad ( EQN . 38 )$$

This yaw βₘ is a heading difference relative to magnetic north, which deviates from true north by an amount known as the declination, which is referred to herein as δ. It is noted that the declination angle for a particular location can be determined, for example, based on the World Magnetic Model (WMM). At 1410, the declination angle is added to the calculated yaw to give the heading or yaw β of the locator from true north.

$$β = {β}_{m} + δ \qquad ( EQN . 39 )$$

The determined yaw, pitch, and roll give the orientation of the locator relative to the NED coordinate system. These angles can be used to apply a series of rotations at 1414 to transform the antenna offset into the local NED coordinate system using:

$$Locator \to NED = {T}_{NED} = {R}_{z} ( - ψ ) {R}_{y} ( - ϕ ) {R}_{x} ( - ψ ) \qquad ( EQN . 40 )$$

where the transform from Locator orientation to orientation in NED, T_{NED}, is based on the rotations Rₓ, R_{y} and R_{z} about the X_{L}, Y_{L} and Z axes, respectively. In particular, where:

$${R}_{x} ( ψ ) = [ \begin{matrix}1 & 0 & 0 \\ 0 & cos ψ & sin ψ \\ 0 & - sin ψ & cos ψ\end{matrix} ] \qquad ( EQN . 41 )$$

$${R}_{y} ( ϕ ) = [ \begin{matrix}cos ϕ & 0 & - sin ϕ \\ 0 & 1 & 0 \\ sin ϕ & 0 & cos ϕ\end{matrix} ] \qquad ( EQN . 42 )$$

$${R}_{z} ( ψ ) = [ \begin{matrix}cos ψ & sin ψ & 0 \\ - sin ψ & cos ψ & 0 \\ 0 & 0 & 1\end{matrix} ] \qquad ( EQN . 43 )$$

To apply this transformation, a vector characterized in the locator coordinate frame is multiplied by the rotation matrices. In the present example, the vector can be the physical offset 62 from the GPS antenna to the triaxial locating antenna which can be characterized as a vector in locator coordinates. As another example, the vector can be any suitable sensor data such as the flux measured by the triaxial locating antenna to obtain corresponding flux values in the NED framework. Essentially, this gives projections of the flux values from the axes of the locator reference system onto the axes of the NED coordinate system. Transformation of the antenna offset to NED coordinates is given as:

$$[ \begin{matrix}{x}_{NED} \\ {y}_{NED} \\ {z}_{NED}\end{matrix} ] = {T}_{{NED}^{*}} [ \begin{matrix}x \\ y \\ z\end{matrix} ] \qquad ( EQN . 44 )$$

$${x}_{NED} = cos ( - ψ ) [ x cos ( - ϕ ) - sin ( - ϕ ) ( - y sin ( - ψ ) + z cos ( - ψ ) ) ] + sin ( - ψ ) [ y cos ( - ψ ) + z sin ( - ψ ) ] \qquad ( EQN . 45 )$$

$${y}_{NE D} = - sin ( - ψ ) [ x cos ( - ϕ ) - sin ( - ϕ ) ( - y sin ( - ψ ) + z cos ( - ψ ) ) ] + cos ( - ψ ) [ y cos ( - ψ ) + z sin ( - ψ ) ] \qquad ( EQN . 46 )$$

$${z}_{NED} = x sin ( - ϕ ) + cos ( - ϕ ) ( - y sin ( - φ ) + z cos ( - φ ) ) \qquad ( EQN . 47 )$$

Now that the triaxial antenna position is expressed in the NED coordinate system, a transformation to an earth-based coordinate system such as, for example, the Earth Centered Earth Fixed (ECEF) coordinate system can be made.

As noted above, the NED coordinate system is a local system which is defined by a point on the surface of the earth that is used as its origin. At this point, down and gravity are perfectly aligned and the north/east plane is tangent to the earth surface. The latitude (lat) and longitude (lon) of the origin, in this instance, the center of triaxial locating antenna 26, define the angles of the NED axes relative to the ECEF axes. At step 1420, a series of rotations can be used to align the axes and transform from NED to ECEF. These rotations can be composed into one transformation that is applied to the NED coordinates, given as:

$${T}_{NED \to ECEF} = [ \begin{matrix}- cos ( lon ) sin ( lat ) & - sin ( lon ) & - cos ( lon ) cos ( lat ) \\ - sin ( lon ) sin ( lat ) & cos ( lon ) & - sin ( lon ) cos ( lat ) \\ cos ( lat ) & 0 & - sin ( lat )\end{matrix} ] \qquad ( EQN . 48 )$$

To find the locating antenna position in ECEF coordinates, the T_{NED} transform of EQN. 40 and the T_{NED→ECEF} transformation of Equation 48 are both applied to the position offset Offset_{GPS→Locating Antenna} from the GPS antenna to the locating antenna. This provides the relative position in the ECEF coordinate system that can then be added to the GPS antenna position to obtain the locating antenna position:

$${P}_{Locate Antenna} = {P}_{GPS} + {T}_{NED \to ECEF} * {T}_{Locator \to NED} * {Offset}_{GPS \to Locating Antenna} \qquad ( EQN . 49 )$$

To express values measured by the locating antenna (i.e., flux measurements) in the NED coordinate system, one of the transformations from Equation 45 can be applied:

$${F}_{NED} = {T}_{Locator \to NED} * {F}_{Locator} \qquad EQN . 50 )$$

where F_{Locator} represents the flux measurements and F_{NED} represents the transformed flux components. It is noted that the result of this transformation gives the flux components as if the locator is level and facing North. To express values measured by the locating antenna in earth-based coordinates, the two transforms of 45 can be applied, as follows:

$${F}_{ECEF} = {T}_{NED \to ECEF} * {T}_{Locator \to NED} * {F}_{Locator} \qquad ( EQN . 51 )$$

It should be appreciated that the flux measurements can be mapped in the earth-based reference system. Likewise, the position of the transmitter can be determined in an earth-based coordinate system whenever a relative offset from the walkover locator to the transmitter is determined by using the NED to ECEF transform, as follows:

$${P}_{T} = {P}_{Locate Antenna} + {T}_{NED \to ECEF} * {RP}_{T} \qquad ( EQN . 52 )$$

where P_{T} is the position of the transmitter in earth-based coordinates, P_{Locate Antenna} is the position of the locating signal antenna in earth-based coordinates and RP_{T} is the relative position of the transmitter in NED coordinates.

The foregoing description of the invention has been presented for purposes of illustration and description. It is not intended to be exhaustive or to limit the invention to the precise form or forms disclosed, and other modifications and variations may be possible in light of the above teachings wherein those of skill in the art will recognize certain modifications, permutations, additions and sub-combinations thereof.

What is claimed is:

1. A walkover locator in a system for tracking a transmitter that is carried by a boring tool for forming a borehole along an underground path, said transmitter including at least one accelerometer for measuring a pitch orientation of the transmitter and configured for transmitting a single axis dipole electromagnetic locating signal having a dipole axis along which a transmitter axis of the transmitter is aligned and having a plane of symmetry that is orthogonal to and bisects the dipole axis, such that the locating signal exhibits a pair of locate points at a surface of the ground, one of which is ahead of the transmitter and another one of which is behind the transmitter, said walkover locator comprising:
a yaw sensor for measuring a yaw orientation of the walkover locator with respect to north;
a triaxial antenna for receiving the dipole electromagnetic signal along three orthogonally arranged receiving axes to generate a set of flux components; and
a processor configured to generate a relative yaw orientation characterizing a difference between the measured yaw orientation of the walkover locator and a reference yaw orientation of the transmitter and to determine an actual position of at least one of the locate points relative to the walkover locator for any location of the walkover locator within a first region on one side of the plane of symmetry and a second region on an opposite side of the plane of symmetry based on at least one measured set of the flux components, the relative yaw orientation and the measured pitch orientation of the transmitter.

2. The walkover locator of claim 1 wherein the processor is further configured to determine an additional position of the other one of the locate points relative to the walkover.

3. The walkover locator of claim 1 wherein the processor is further configured to determine another relative positional relationship between the walkover locator and the transmitter.

4. The walkover locator of claim 1, further comprising:
a display driven by said processor to illustrate the relative positional relationship including the walkover locator and at least one of the locate points.

5. The walkover locator of claim 4 wherein the processor is configured to drive the display such that the display identifies at least one of the locate points as one of a front locate point and a rear locate point.

6. The walkover locator of claim 4 wherein the processor drives the display to illustrate the relative positional relationship as at least one of a plan view in two dimensions and at least one perspective view in three dimensions.

7. The walkover locator of claim 6 further comprising a user interface for a user to select between a plurality of locating display modes including at least the plan view in a plan view mode and the perspective view for illustration by the display.

8. The walkover locator of claim 7 wherein the plurality of display modes further includes a hybrid mode such that the display illustrates the perspective view as a main view and the plan view as an inset view.

9. The walkover locator of claim 7 wherein the plurality of display modes further includes a hybrid mode with plan view preferred such that the display illustrates the plan view as a main view and the perspective view as an inset view.

10. The walkover locator of claim 1 further comprising a user interface for a user to identify at least one of a locate line and a locate line point in addition to at least one of the locate points.

11. A method in a walkover locator for tracking a transmitter that is carried by a boring tool for forming a borehole along an underground path, said transmitter including at least one accelerometer for measuring a pitch orientation of the transmitter and configured for transmitting a single axis dipole electromagnetic locating signal having a dipole axis along which a transmitter axis of the transmitter is aligned and having a plane of symmetry that is orthogonal to and bisects the dipole axis, such that the locating signal exhibits a pair of locate points at a surface of the ground, one of which is ahead of the transmitter and another one of which is behind the transmitter, said method comprising:
measuring a yaw orientation of the walkover locator with respect to north;
receiving the dipole electromagnetic signal along three orthogonally arranged receiving axes to generate a set of flux components;
generating a relative yaw orientation characterizing a difference between the measured yaw orientation of the walkover locator and a reference yaw orientation of the transmitter; and
determining an actual position of at least one of the locate points relative to the walkover locator for any location of the walkover locator within a first region on one side of the plane of symmetry and a second region on an opposite side of the plane of symmetry based on at least one measured set of the flux components, the relative yaw orientation and the measured pitch orientation of the transmitter.

12. The method of claim 11, further comprising:
displaying the relative positional relationship including the walkover locator and at least one of the locate points.

13. In a system for tracking a transmitter that is carried by a boring tool for forming a borehole along an underground path, said transmitter including at least one accelerometer for measuring a pitch orientation of the transmitter and configured for transmitting a single axis dipole electromagnetic locating signal having a dipole axis along which a transmitter axis of the transmitter is aligned and having a plane of symmetry that is orthogonal to and bisects the dipole axis, such that the locating signal exhibits a pair of locate points at a surface of the ground, one of which is ahead of the transmitter and another one of which is behind the transmitter, a display comprising:
a processor configured to determine an actual position of at least one of the locate points relative to the walkover locator for any location of the walkover locator within a first region on one side of the plane of symmetry and a second region on an opposite side of the plane of symmetry based on at least one measured set of the flux components, the relative yaw orientation and the measured pitch orientation of the transmitter; and
a display screen driven by said processor to illustrate the relative positional relationship including the walkover locator and at least one of the locate points.

14. A walkover locator in a system for tracking a transmitter that is carried by a boring tool for forming a borehole along an underground path within a region, said transmitter including at least one accelerometer for measuring a pitch orientation of the transmitter and configured for transmitting a single axis dipole electromagnetic locating signal having a dipole axis along which a transmitter axis of the transmitter is aligned and having a plane of symmetry that is orthogonal to and bisects the dipole axis, such that the locating signal exhibits a pair of locate points at a surface of the ground, one of which is ahead of the transmitter and another one of which is behind the transmitter, said walkover locator comprising:
a yaw sensor for measuring a yaw orientation of the walkover locator with respect to north;
a triaxial antenna for receiving the dipole electromagnetic signal along three orthogonally arranged receiving axes to generate a set of flux components;
a processor configured to generate a relative yaw orientation characterizing a difference between the measured yaw orientation of the walkover locator and a reference yaw orientation of the transmitter and to determine a relative positional relationship between the walkover locator and each one of the locate points for any location of the walkover locator within a first region on one side of the plane of symmetry and a second region on an opposite side of the plane of symmetry based on at least one measured set of the flux components, the relative yaw orientation and the measured pitch orientation of the transmitter; and
a display driven by said processor to display the relative positional relationship including the walkover locator and both of the locate points.

15. The walkover locator of claim 14 wherein the processor is further configured to determine another relative positional relationship between the walkover locator and the transmitter and the display additionally displays a position of the transmitter based on the other positional relationship.

16. The walkover locator of claim 15 wherein said processor drives said display to show the locate points, the walkover locator and the transmitter in three dimensions.

17. The walkover locator of claim 14 wherein the processor is configured to drive the display such that the display identifies at least one of the locate points as one of a front locate point and a rear locate point.

18. The walkover locator of claim 14 wherein the processor drives the display to illustrate the relative positional relationship as at least one of a plan view in two dimensions and a perspective view in three dimensions.

19. The walkover locator of claim 18 further comprising a user interface for a user to select between a plurality of locating display modes including at least the plan view in a plan view mode and the perspective view for illustration by the display.

20. The walkover locator of claim 19 wherein the plurality of display modes further includes a hybrid mode such that the display illustrates the perspective view as a main view and the plan view as an inset view.

21. The walkover locator of claim 19 wherein the plurality of display modes further includes a hybrid mode with plan view preferred such that the display illustrates the plan view as a main view and the perspective view as an inset view.

22. A walkover locator in a system for tracking a transmitter that is carried by a boring tool for forming a borehole along an underground path within a region, said transmitter including at least one accelerometer for measuring a pitch orientation of the transmitter and configured for transmitting a single axis dipole electromagnetic locating signal having a dipole axis along which a transmitter axis of the transmitter is aligned and having a plane of symmetry that is orthogonal to and bisects the dipole axis, such that the locating signal exhibits a pair of locate points at a surface of the ground, one of which is ahead of the transmitter and another one of which is behind the transmitter, said walkover locator comprising:
a yaw sensor for measuring a yaw orientation of the walkover locator with respect to north;
a triaxial antenna for receiving the dipole electromagnetic signal along three orthogonally arranged receiving axes to generate a set of flux components; and
a processor configured to generate a relative yaw orientation characterizing a difference between the measured yaw orientation of the walkover locator and a reference yaw orientation of the transmitter and to determine a first relative positional relationship between the walkover locator and the transmitter in three dimensions and a second relative positional relationship between the walkover locator and at least one of the locate points in at least two dimensions for any location of the walkover locator within a first region on one side of the plane of symmetry and a second region on an opposite side of the plane of symmetry based on at least one measured set of the flux components, the relative yaw orientation and the measured pitch orientation of the transmitter.

23. The walkover locator of claim 22, further comprising:
a display driven by said processor to display the first relative positional relationship and the second relative positional relationship including the walkover locator, at least one of the locate points and the transmitter.

24. The walkover locator of claim 22 wherein the processor is configured to drive the display such that the display identifies at least one of the locate points as one of a front locate point and a rear locate point.

25. The walkover locator of claim 22 further comprising a user interface for a user to identify at least one of a locate line and a locate line point for display in addition to at least one of the locate points.

26. A walkover locator in a system for tracking a transmitter that is carried by a boring tool for forming a borehole along an underground path, said transmitter including at least one accelerometer for measuring a pitch orientation of the transmitter and configured for transmitting a single axis dipole electromagnetic locating signal having a dipole axis along which a transmitter axis of the transmitter is aligned such that the locating signal exhibits a pair of locate points at a surface of the ground, one of which is ahead of the transmitter and another one of which is behind the transmitter, said walkover locator comprising:
a triaxial antenna for receiving the dipole electromagnetic signal along three orthogonally arranged receiving axes to generate a set of flux components;
a GPS receiver having a GPS output for generating positional coordinates that identify a current position of the walkover locator; and
a processor configured to (i) identify the front locate point and the rear locate point and record a front locate point GPS position and a rear locate point GPS position, respectively, based on the measured flux components and the GPS output and (ii) determine coordinates associated with an overhead point above the transmitter and between the front locate point and rear locate point based on the front locate point GPS position, the rear locate point GPS position and the measured pitch.

27. The walkover locator of claim 26 wherein the processor identifies the front locate point and the rear locate point by distinguishing therebetween based, at least in part, on at least one previous positional determination that characterizes a prior position of the transmitter.

28. The walkover locator of claim 26 further comprising a yaw sensor that generates a yaw output and the processor identifies the front locate point and the rear locate point by distinguishing therebetween based, at least in part, on the yaw output.

29. The walkover locator of claim 28 wherein said processor is further configured for determining a depth of the transmitter below the overhead point.

30. The walkover locator of claim 29 wherein said processor determines the depth of the transmitter in an earth-based coordinate system.

31. The walkover locator of claim 26 wherein the processor is configured to determine a transmitter yaw line extending between the front locate point and rear locate point based on the front locate point GPS position and the rear locate point GPS position and establish a position of the overhead point as a distance from at least one of the front locate point and the rear locate point along the transmitter yaw line and between the front locate point and the rear locate point.

32. The walkover locator of claim 31 wherein the processor is configured to determine an overhead line extending through the overhead point and normal to the transmitter yaw line at the surface of the ground.

33. The walkover locator of claim 31 wherein the processor is configured to determine coordinates of the locate line at the surface of the ground at which flux lines of the electromagnetic locating signal are horizontally oriented.

34. The walkover locator of claim 26 wherein the processor is configured to determine an elevation difference between the front locate point and the rear locate point based on the recorded front locate point position and the recorded rear locate point position and, thereafter, determine the coordinates of the overhead point in three dimensions based on the elevation difference in conjunction with the front locate point GPS position, the rear locate point GPS position and the measured pitch.

35. The walkover locator of claim 26 further comprising:
a display for displaying a relative relationship at least between the overhead point and a current position of the walkover locator.

36. The walkover locator of claim 35 wherein said processor is further configured to update the current position as the walkover locator is moved in relation to the overhead point.

37. A walkover locator in a system for tracking a transmitter that is carried by a boring tool for forming a borehole along an underground path, said transmitter including at least one accelerometer for measuring a pitch orientation of the transmitter and configured for transmitting a single axis dipole electromagnetic locating signal having a dipole axis along which a transmitter axis of the transmitter is aligned such that the locating signal exhibits a pair of locate points at a surface of the ground, one of which is ahead of the transmitter and another one of which is behind the transmitter, said walkover locator comprising:
a triaxial antenna for receiving the dipole electromagnetic signal along three orthogonally arranged receiving axes to generate a set of flux components;
a GPS receiver having a GPS output for generating positional coordinates that identify a current position of the walkover locator;
a processor configured to (i) identify the front locate point and the rear locate point and record a front locate point GPS position and a rear locate point GPS position, respectively, based on the measured flux components and the GPS output (ii) determine coordinates associated with a transmitter yaw line extending between the front locate point and rear locate point based on the front locate point GPS position and the rear locate point GPS position, (iii) measure the locating signal to determine a first component of the current position of the walkover locator along the transmitter yaw line with reference to the GPS output and read a current set of GPS coordinates from the GPS receiver to determine a second component of the current position in a direction that is laterally offset from the transmitter yaw line for providing guidance, in conjunction with the measured pitch, to move the walkover locator to at least one of an overhead point at the surface of the ground directly above the transmitter and the overhead line such that the second component is more accurate than determining a lateral offset from the transmitter yaw line using just the locating signal.

38. The walkover locator of claim 37 wherein the processor identifies the front locate point and the rear locate point by distinguishing therebetween based, at least in part, on at least one previous positional determination that characterizes a prior position of the transmitter.

39. The walkover locator of claim 37 further comprising a yaw sensor that generates a yaw output and the processor identifies the front locate point and the rear locate point by distinguishing therebetween based, at least in part, on the yaw output.

40. The walkover locator of claim 37 wherein said processor is further configured to update the current position as the walkover locator is moved.

41. The walkover locator of claim 37 wherein said processor is further configured to detect a flux orientation of the locating signal based on the measured pitch that is indicative of the overhead point as the first component of the current position of the walkover locator.

42. The walkover locator of claim 41, further comprising:
a display for displaying guidance to direct an operator to the overhead point.

43. The walkover locator of claim 37 wherein the locating signal exhibits a locate line at the surface of the ground between the locate points and extending orthogonal to the transmitter axis such that a flux orientation of the locating signal at the locate line is horizontally oriented and the processor is further configured to provide guidance to the locate line.

44. A portable locator apparatus as part of an inground locating system for locating a transmitter that transmits an electromagnetic locating signal from underground, said apparatus comprising:
a locator housing;
a triaxial antenna supported by the housing for receiving the electromagnetic locating signal to generate a locating signal output for tracking the transmitter;
a GPS module supported by the housing and including a GPS antenna that is at a predetermined offset from the triaxial antenna with reference to the housing, said GPS module generating a GPS position output that characterizes a GPS position of the GPS antenna;
a yaw sensor producing a yaw orientation output; and
a processor that determines a location of the triaxial antenna in earth-based coordinates at least based on the predetermined offset, the yaw orientation and the GPS position of the GPS antenna.

45. The apparatus of claim 44 wherein the yaw sensor is a magnetometer such that the yaw orientation is a magnetometer output.

46. The apparatus of claim 45 wherein the apparatus further comprises:
a triaxial accelerometer producing an accelerometer output that characterizes a tilt orientation of the apparatus; and
said processor further configured to determine the location of the triaxial antenna based on the tilt orientation in conjunction with the predetermined offset, the yaw orientation and the GPS position of the GPS antenna.

47. The apparatus of claim 44 wherein the GPS module is removably attachable to the portable locator in said predetermined relationship.

48. A walkover locator in a system for tracking a transmitter that is carried by a boring tool for forming a borehole along an underground path, said transmitter configured for measuring a pitch orientation of the transmitter and for transmitting a dipole locating signal, characterizing the measured pitch orientation, the dipole locating signal having a dipole axis along which a transmitter axis of the transmitter is aligned, said walkover locator comprising:
a triaxial antenna for receiving the dipole locating signal along three orthogonally arranged receiving axes to generate a set of flux components;
a processor configured to measure the flux components and generate a flux pitch of the dipole locating signal and, responsive to the flux pitch of the dipole locating signal matching the measured pitch orientation of the transmitter, determine a yaw heading of the transmitter relative to a current orientation of the walkover locator.

49. The walkover locator of claim 48 further comprising:
a display driven by said processor to show the flux pitch for comparison with the current measured pitch orientation.

50. The walkover locator of claim 48 wherein said processor determines the yaw heading as a projection of the measured flux components onto a horizontal plane.

51. A walkover locator in a system for tracking a transmitter that is carried by a boring tool for forming a borehole along an underground path, said transmitter including at least one accelerometer for measuring a pitch orientation of the transmitter and configured for transmitting a single axis dipole electromagnetic locating signal having a dipole axis along which a transmitter axis of the transmitter is aligned and having a plane of symmetry that is orthogonal to and bisects the dipole axis, such that the locating signal exhibits a pair of locate points at a surface of the ground, one of which is ahead of the transmitter and another one of which is behind the transmitter, said walkover locator comprising:
a yaw sensor for measuring a yaw orientation of the walkover locator with respect to north;
a triaxial antenna for receiving the dipole electromagnetic signal along three orthogonally arranged receiving axes to generate a set of flux components;
a GPS unit for outputting GPS readings that specify a current position of the walkover locator; and
a processor configured (i) to determine an actual position at least of an overhead point directly above the transmitter at the surface of the ground in a first locating mode for any location of the walkover locator within a first region on one side of the plane of symmetry and a second region on an opposite side of the plane of symmetry at least based on the set of flux measurements and the measured yaw orientation wherein the first locating mode is unstable in the plane of symmetry and (ii) to determine the actual position of the overhead point in a second locating mode based at least on the GPS readings and the set of flux measurements with the walkover locator in the plane of symmetry wherein the second locating mode is stable in the plane of symmetry.

52. The walkover locator of claim 51 wherein the processor is further configured for switching between the first locating mode and the second locating mode based on a proximity of the walkover locator to the plane of symmetry such that the walkover locator operates in the first locating mode when offset from the plane of symmetry and in the second locating mode when in the plane of symmetry.

53. The walkover locator of claim 52 wherein said processor is further configured to determine said proximity to the plane of symmetry based on a current pitch of the transmitter compared to a slope of local flux lines based on the set of flux components measured at a current location of the walkover locator.

54. The walkover locator of claim 53 wherein the processor switches from the first locating mode to the second locating mode when the slope of the local flux lines is within a threshold value from the current pitch of the transmitter.

55. The walkover locator of claim 54 wherein the threshold value is in a range from 2 degrees to 20 degrees.

56. The walkover locator of claim 51 further comprising:
a display configured such that an operator can switch between the first locating mode and the second locating mode.

57. The walkover locator of claim 51 wherein said processor is configured for automatic switching between the first locating mode and the second locating mode.
